(19) United States
(12) Patent Application Publication
(10) Pub. No.: US 2025/0360926 A1
(43) Pub. Date: Nov. 27, 2025

(54) AUTOMATED DRIVING CONTROL DEVICE

(71) Applicant: DENSO CORPORATION, Kariya-city (JP)

(72) Inventors: Kazuki IZUMI, Kariya-city (JP); Yuuki OZAWA, Tokyo (JP); Ryu KAMBARA, Tokyo (JP); Koji SHIBATA, Tokyo (JP); Yuka SATRE, Tokyo (JP); Yuki YAMAMOTO, Tokyo (JP)

(21) Appl. No.: 19/293,801

(22) Filed: Aug. 7, 2025

Related U.S. Application Data
(63) Continuation of application No. PCT/JP2024/005302, filed on Feb. 15, 2024.

(30) Foreign Application Priority Data
Feb. 17, 2023 (JP) 2023-023002

(51) Int. Cl. B60W 30/18; B60Q 1/34; B60Q 1/50; B60W 30/12; B60W 30/14; B60W 30/16; B60W 50/00; B60W 60/00

(52) U.S. Cl. CPC B60W 30/18163; B60Q 1/346; B60Q 1/507; B60W 30/12; B60W 30/143; B60W 30/16; B60W 30/18154; B60W 30/18159; B60W 50/0097; B60W 60/001; B60Q 2800/10; B60W 2554/4029; B60W 2554/4041; B60W 2554/4045; B60W 2554/4046; B60W 2554/80; B60W 2555/20; B60W 2555/60

(57) ABSTRACT

An automated driving control device enables traveling of a subject vehicle by an automated driving function. The automated driving control device is configured to grasp, in a scene where the subject vehicle is scheduled to pass through an intersection, whether there is a space for the subject vehicle in a subject vehicle lane ahead of the intersection; and determine, in a case where there is not the space in the subject vehicle lane, execution of a lane change in a direction in which the subject vehicle leaves the subject vehicle lane in a section including the intersection. The automated driving control device makes a lateral vector generated in the subject vehicle in the lane change in the section including the intersection smaller than a lateral vector in the lane change in a section not including the intersection.

### CROSS REFERENCE TO RELATED APPLICATIONS

The present application is a continuation application of International Patent Application No. PCT/JP2024/005302 filed on Feb. 15, 2024 which designated the U.S. and claims the benefit of priority from Japanese Patent Application No. 2023-023002 filed on Feb. 17, 2023. The entire disclosures of all of the above applications are incorporated herein by reference.

### TECHNICAL FIELD

The disclosure according to this specification relates to a technique of automated driving control that enables traveling of a subject vehicle by an automated driving function.

### BACKGROUND

In the automated driving device disclosed in a related art, the manual driving switching threshold value having a low value is calculated in a case where the subject vehicle is traveling through an intersection, in a case where an obstacle around the subject vehicle is recognized, or the like. In a case where the operation amount of the driver is equal to or greater than the manual driving switching threshold value, the automated driving device switches the automated driving being executed to the manual driving.

### SUMMARY

According to an aspect of the present disclosure, an automated driving control device that enables traveling of a subject vehicle by an automated driving function is provided. The automated driving control device includes at least one of (i) a circuit and (ii) a processor with a memory storing computer program code executable by the processor, the at least one of the circuit and the processor configured to cause the automated driving control device to grasp, in a scene where the subject vehicle is scheduled to pass through an intersection, whether there is a space for the subject vehicle in a subject vehicle lane ahead of the intersection; and determine, in a case where there is not the space in the subject vehicle lane, execution of a lane change in a direction in which the subject vehicle leaves the subject vehicle lane in a section including the intersection. The automated driving control device may make a lateral vector generated in the subject vehicle in the lane change in the section including the intersection smaller than a lateral vector in the lane change in a section not including the intersection.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an overall image of an in-vehicle network including an automated driving ECU according to the first embodiment of the present disclosure;

FIG. 2 is a block diagram illustrating details of an automated driving ECU;

FIG. 3 is a diagram for describing the scene 1 in which an automated lane change is performed in a section including an intersection;

FIG. 4 is a diagram for describing the scene 2 in which an automated lane change is performed in a section including an intersection;

FIG. 5 is a diagram for describing the scene 3 in which an automated lane change is performed in a section including an intersection;

FIG. 6 is a diagram for describing the scene 4 in which an automated lane change is performed in a section including an intersection;

FIG. 7 is a diagram for describing the scene 5 in which an automated lane change for avoiding an emergency vehicle is performed;

FIG. 8 is a diagram for describing the scene 6 in which the automated lane change is stopped in the section including the intersection;

FIG. 9 is a diagram for describing the scene 7 in which an automated lane change is in a standby state in a section including an intersection;

FIG. 10 is a diagram for describing the scene 8 in which an automated lane change is continuously performed inside and outside an intersection;

FIG. 11 is a flowchart illustrating details of the execution determination process;

FIG. 12 is a flowchart illustrating details of the lane change control process;

FIG. 13 is a diagram for describing the scene 9 in which an automated lane change is performed in accordance with a right turn in a section including an intersection in the second embodiment of the present disclosure;

FIG. 14 is a diagram for describing the scene 10 in which an automated lane change is performed in a section including an intersection;

FIG. 15 is a diagram for describing the scene 11 in which an automated lane change for avoiding an emergency vehicle is performed;

FIG. 16 is a diagram for describing the scene 12 in which an automated lane change is performed in a section including an intersection; and

FIG. 17 is a diagram for describing the scene 13 in which the automated lane change is canceled in the section including the intersection.

### DETAILED DESCRIPTION

For example, in a case where the surroundings of the subject vehicle are congested, there may be a case where there is not the space for the subject vehicle in the subject vehicle lane ahead of the intersection. A related art does not describe any travel control assuming such a case. Therefore, a situation in which the subject vehicle that has entered the intersection by the control of the automated driving device stays in the intersection may occur, and the convenience of the automated driving may be impaired.

The present disclosure provides an automated driving control device, an automated driving control program, and an automated driving control method capable of securing convenience of automated driving.

According to one aspect of the present disclosure, an automated driving control device that enables traveling of a subject vehicle by an automated driving function includes: a situation grasping section configured to grasp, in a scene where the subject vehicle is scheduled to pass through an intersection, whether there is a space for the subject vehicle in a subject vehicle lane ahead of the intersection; and a travel control section configured to determine, in a case where there is not the space in the subject vehicle lane, execution of a lane change in a direction in which the subject vehicle leaves the subject vehicle lane in a section including the intersection. The travel control section makes a lateral vector generated in the subject vehicle in the lane change in the section including the intersection smaller than a lateral vector in the lane change in a section not including the intersection.

According to one aspect of the present disclosure, an automated driving control device that enables traveling of a subject vehicle by an automated driving function includes: a situation grasping section configured to grasp, in a scene where the subject vehicle is scheduled to pass through an intersection, grasps whether there is a space for the subject vehicle in a subject vehicle lane ahead of the intersection; and a travel control section configured to determine, in a case where there is not the space in the subject vehicle lane, execution of a lane change in a direction in which the subject vehicle leaves the subject vehicle lane in a section including the intersection. The situation grasping section determines whether a pedestrian is present in a waiting area facing the intersection, and the travel control section, in a case where the pedestrian is present in the waiting area, completes the lane change within an area of the intersection.

According to one aspect of the present disclosure, an automated driving control device that enables traveling of a subject vehicle by an automated driving function includes: a situation grasping section configured to grasp, in a scene where the subject vehicle is scheduled to pass through an intersection, whether there is a space for the subject vehicle in a subject vehicle lane ahead of the intersection; and a travel control section configured to determine, in a case where there is not the space in the subject vehicle lane, execution of a lane change in a direction in which the subject vehicle leaves the subject vehicle lane in a section including the intersection. The situation grasping section grasps whether a crosswalk is provided at the intersection, and the travel control section, in a case where the crosswalk is provided at the intersection, completes the lane change before the crosswalk.

In these aspects, even in a case where there is no space for the subject vehicle in the subject vehicle lane ahead of the intersection, the subject vehicle can be caused to leave the intersection by changing the traveling lane due to the lane change in the section including the intersection. Therefore, a situation in which the subject vehicle stays in the intersection is not likely to occur. As a result, the convenience of the automated driving can be secured.

Hereinafter, a plurality of embodiments of the present disclosure will be described with reference to the drawings. The same reference numerals are given to corresponding components in each embodiment, and redundant description may be omitted. In a case where only part of the configuration is described in each embodiment, the configuration of the other embodiments described above can be applied to other parts of the configuration. In addition, not only a combination of configurations explicitly described in the description of each embodiment but also configurations of a plurality of embodiments can be partially combined even if not explicitly described as long as there is no problem in the combination. It is assumed that combinations of configurations described in a plurality of embodiments and modifications that is not explicitly described are also disclosed by the following description.

### First Embodiment

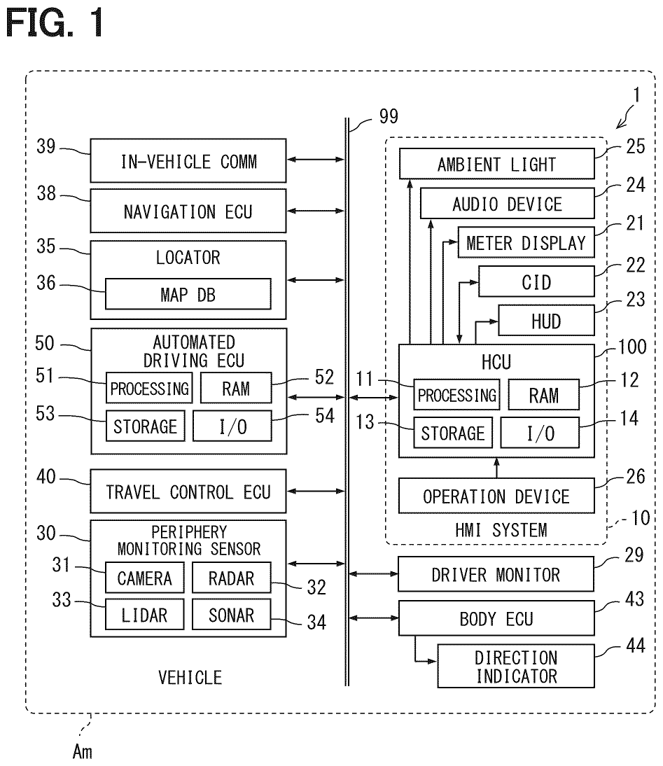

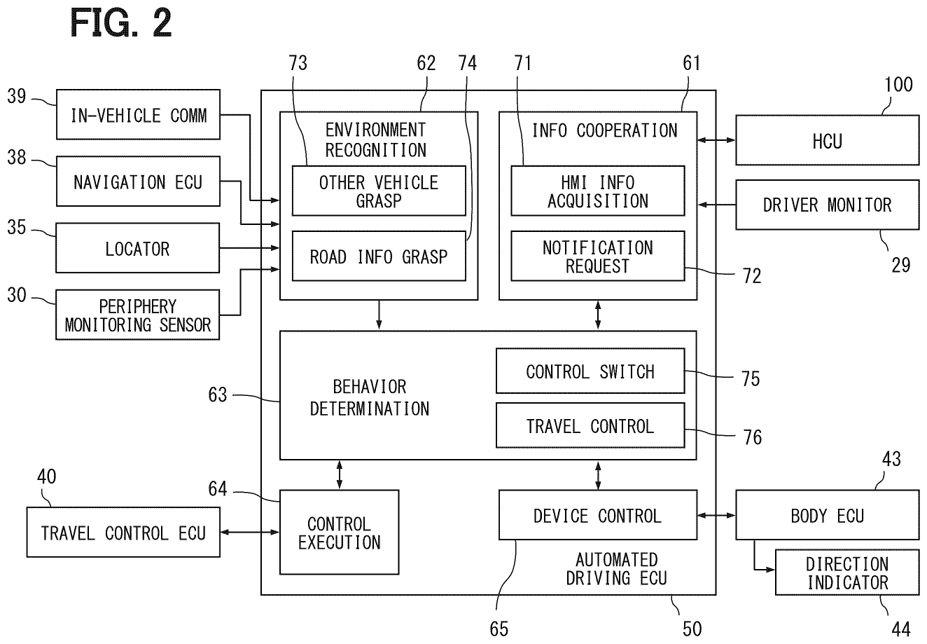

The function of the automated driving control device according to the first embodiment of the present disclosure is realized by an automated driving electronic control section (ECU) 50 illustrated in FIGS. 1 and 2. The automated driving ECU 50 is mounted on a vehicle (hereinafter, subject vehicle Am). By mounting the automated driving ECU 50, the subject vehicle Am is an automated driving vehicle or an autonomous traveling vehicle having an automated driving function, and can travel by the automated driving function.

The automated driving ECU 50 is an in-vehicle ECU that realizes an autonomous traveling function capable of performing a driving operation of a driver on behalf of the driver. The automated driving ECU 50 can perform advanced driving assistance or partial automated driving at about Level 2 and automated driving at Level 3 or higher in which the system is a control subject. The automated driving level in the present disclosure is based on a standard defined by Society of Automotive Engineers.

The automated driving at Level 2 is an automated driving (an eyes-on automated driving) that requires a driver to visually monitor the surroundings of the subject vehicle and has a surroundings monitoring obligation. The automated driving at Level 2 includes hands-on automated driving in which the driver is obliged to grip the steering wheel and hands-off automated driving in which the driver is not obliged to grip the steering wheel.

The automated driving at Level 3 is an eyes-off automated driving in which monitoring around the subject vehicle is unnecessary and there is no surroundings monitoring obligation. The automated driving ECU 50 may be capable of performing fully automated driving at Level 4 in which the system performs all driving tasks under certain conditions, and fully automated driving at Level 5 in which the system performs all driving tasks under all conditions. The automated driving at Level 4 is brain-off automated driving in which a request for a driving-mode switch to the driver does not substantially occur. The automated driving at Level 5 is driverless automated driving that does not require a driver to board.

The automated driving ECU 50 switches the control state of the automated driving function among a plurality of controls including at least automated driving control having a surroundings monitoring obligation at Level 2 or less and automated driving control having no surroundings monitoring obligation at Level 3 or more. In the following description, the automated driving control at Level 2 or lower is referred to as “driving assistance control”, and the automated driving control at Level 3 or higher is referred to as “autonomous travel control”.

In the automated traveling period during which the subject vehicle Am travels by the autonomous travel control, the driver can be permitted to perform a specific action (hereinafter, a second task) other than predetermined driving. The second task is legally permitted to the driver until generation of a driving-mode switch request performed by cooperation of a human machine interface control section (HCU) 100 and the automated driving ECU 50 described later. For example, actions such as viewing entertainment content such as moving image content, operation of a device such as a smartphone, and eating are assumed as the second tasks.

(Configuration of in-Vehicle System)

The automated driving ECU 50 is communicably connected to a communication bus 99 of an in-vehicle network 1 mounted on the subject vehicle Am. A driver monitor 29, a surroundings monitoring sensor 30, a locator 35, a navigation ECU 38, an in-vehicle communication device 39, a travel control ECU 40, a body ECU 43, an HCU 100, and the like are connected to the communication bus 99. These nodes connected to the communication bus 99 can communicate with each other. Specific nodes among these ECUs and the like may be electrically connected directly to each other and may communicate with each other without passing through the communication bus 99.

The driver monitor 29 includes a near-infrared light source, a near-infrared camera, and a control unit that controls these components. The driver monitor 29 is installed, for example, on the upper face of the steering column section or the upper face of the instrument panel in a posture in which the near-infrared camera faces the headrest portion of the driver seat. The driver monitor 29 photographs the head of the driver irradiated with the near-infrared light by the near-infrared light source with the near-infrared camera. The image captured by the near-infrared camera is subjected to image analysis by the control unit. The control unit extracts information such as the position and the line-of-sight direction of the eye point of the driver from the captured image. The driver monitor 29 provides the position information, the line-of-sight direction information, and the like of the eye point extracted by the control unit to the HCU 100, the automated driving ECU 50, and the like as driver status information.

The surroundings monitoring sensor 30 is an autonomous sensor that monitors the environment around the subject vehicle Am. The surroundings monitoring sensor 30 includes, for example, one or more of a camera unit 31, a millimeter wave radar 32, a LiDAR 33, and a sonar 34. The surroundings monitoring sensor 30 can detect a moving object and a stationary object from a detection range around the subject vehicle. The surroundings monitoring sensor 30 provides detection information about an object around the subject vehicle to the automated driving ECU 50 and the like. The surroundings monitoring sensor may be referred to as a periphery monitoring sensor.

The locator 35 includes a global navigation satellite system (GNSS) receiver, an inertial sensor, and the like. The locator 35 combines positioning signals received from a plurality of positioning satellites by the GNSS receiver, measurement results by the inertial sensor, vehicle speed information output to the communication bus 99, and the like to sequentially measure the position, the traveling direction, and the like of the subject vehicle Am. The locator 35 sequentially outputs the position information and the direction information of the subject vehicle Am based on the positioning result to the communication bus 99 as locator information.

The locator 35 further includes a map database (hereinafter, map DB) 36 storing map data. The map DB 36 mainly includes a large-capacity storage medium storing a large number of pieces of three-dimensional map data and two-dimensional map data. The three-dimensional map data is a so-called high definition (HD) map, and includes road information necessary for automated driving. Specifically, the three-dimensional map data includes three-dimensional shape information of the road, detailed information of each lane, and the like. The locator 35 can update the three-dimensional map data and the two-dimensional map data to the latest information by out-of-vehicle communication by the in-vehicle communication device 39. The locator 35 reads map data around the current position from the map DB 36, and provides the map data together with locator information to the automated driving ECU 50, the HCU 100, and the like.

The navigation ECU 38 acquires information about a destination designated by an occupant such as a driver based on the operation information acquired from the HCU 100. The navigation ECU 38 acquires subject vehicle position information and direction information from the locator 35, and sets a route from the current position to the destination. The navigation ECU 38 provides route information indicating a setting route to a destination to the automated driving ECU 50, the HCU 100, and the like. The navigation ECU 38 cooperates with an HMI system 10 to combine a screen display, a voice message, and the like as route guidance to the destination, and notifies the driver of the traveling direction of the subject vehicle Am at the intersection, the branch point, and the like.

Here, a user terminal such as a smartphone may be connected to the in-vehicle network 1 or the HCU 100. Such a user terminal may provide subject vehicle position information, direction information, map data, and the like to the automated driving ECU 50 and the like instead of the locator 35. Further, instead of the navigation ECU 38, the user terminal may provide route information to the destination to the automated driving ECU 50, the HCU 100, and the like.

The in-vehicle communication device 39 is an out-of-vehicle communication unit mounted on the subject vehicle Am, and functions as a vehicle to everything (V2X) communication device. The in-vehicle communication device 39 transmits and receives information to and from a roadside device installed beside the road and another vehicle around the subject vehicle by wireless communication. As an example, the in-vehicle communication device 39 receives congestion information, traffic regulation information, and the like around the current position and in the traveling direction of the subject vehicle Am from a roadside device. The congestion information and the traffic regulation information are, for example, VICS (registered trademark) information and the like.

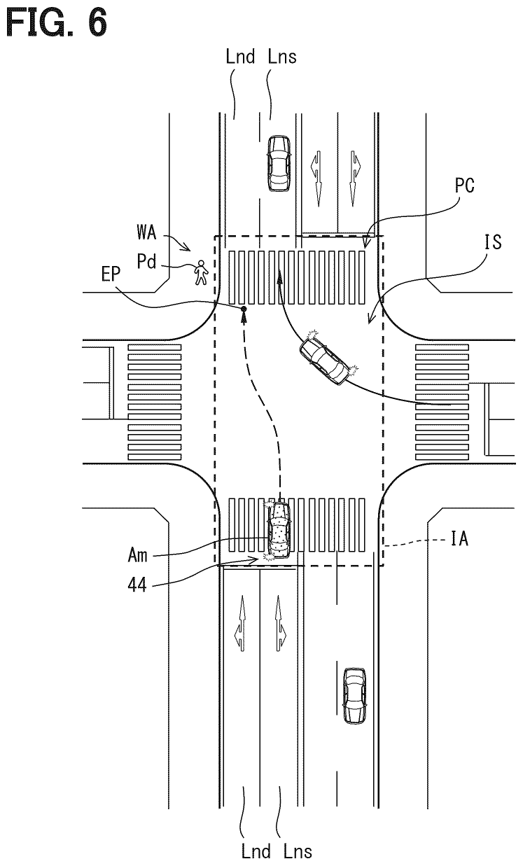

The in-vehicle communication device 39 may be capable of receiving signal information indicating a lighting pattern of a traffic signal installed at the preceding intersection, and detection information about objects around the preceding intersection, for example, a stopped vehicle, a parked vehicle, a pedestrian Pd (see FIG. 6), a cyclist, and the like from a roadside device and another vehicle. The in-vehicle communication device 39 provides the received congestion information, traffic regulation information, signal information, detection information, and the like to the automated driving ECU 50, the HCU 100, and the like.

The travel control ECU 40 is an electronic control device mainly including a microcontroller. The travel control ECU 40 generates vehicle speed information indicating the current traveling speed of the subject vehicle Am based on the detection signal of the wheel speed sensor provided in the hub portion of each wheel, and sequentially outputs the generated vehicle speed information to the communication bus 99. The travel control ECU 40 has at least functions of a brake control ECU, a drive control ECU, and a steering control ECU. The travel control ECU 40 continuously performs braking force control of each wheel, output control of an in-vehicle power source, and steering angle control based on an operation command based on a driving operation of a driver or a control command of the automated driving ECU 50.

The body ECU 43 is an electronic control device mainly including a microcontroller. The body ECU 43 has at least a function of controlling an operation of a lighting device (for example, the direction indicator 44 or the like) mounted on the subject vehicle Am. The body ECU 43 starts blinking of one of left and right direction indicators 44 (blinker) corresponding to an operation direction based on detection of a user operation input to a direction indication switch provided in a steering column section or the like. In addition, based on the control command received from the automated driving ECU 50, the body ECU 43 causes one of the left and right direction indicators 44 corresponding to the moving direction of the subject vehicle Am to start blinking in a case of the automated lane change by the driving assistance control or the autonomous travel control.

The HCU 100 constitutes a human machine interface (HMI) system 10 together with a plurality of display devices, an audio device 24, an ambient light 25, an operation device 26, and the like. The HMI system 10 has an input interface function of receiving an operation by an occupant such as a driver of the subject vehicle Am and an output interface function of presenting information to the driver.

The display device presents information through the vision of the driver by image display or the like. The display devices include a meter display 21, a center information display (CID) 22, a head-up display (hereinafter, HUD) 23, and the like. The CID 22 has a touch panel function, and detects a touch operation on a display screen by a driver or the like.

The audio device 24 includes a plurality of speakers installed in the vehicle interior in an arrangement surrounding the driver seat, and causes the speakers to reproduce a notification sound, a voice message, or the like in the vehicle interior. The ambient light 25 is provided on an instrument panel, a steering wheel, and the like. The ambient light 25 performs information presentation using the surroundings field of view of the driver by ambient display that changes the emission color.

The operation device 26 is an input section that receives a user operation by a driver or the like. For example, a user operation related to the operation and stop of the automated driving function, a user operation related to the setting of the destination of the route guidance, and the like are input to the operation device 26. The operation device 26 includes a steering switch provided on a spoke portion of a steering wheel, an operation lever provided on a steering column section, a voice input device that recognizes utterance content of a driver, and the like.

The HCU 100 is a computer mainly including a control circuit including a processing section 11, a RAM 12, a storage section 13, an input/output interface 14, a bus connecting these, and the like. The HCU 100 functions as a presentation control device, and integrally controls information presentation using a plurality of display devices, the audio device 24, and the ambient light 25.

The HCU 100 presents information related to the automated driving in cooperation with the automated driving ECU 50. The HCU 100 acquires, from the automated driving ECU 50, control status information indicating an operation state of the automated driving function and a request for execution of information presentation related to the automated driving function. The HCU 100 performs content provision and information presentation in accordance with the operation state of the automated driving based on the control status information and the execution request. For example, in a case where the autonomous travel control is scheduled to be terminated by the automated driving ECU 50, the HCU 100 makes a notification of requesting execution of the driving operation, in other words, a notification of requesting a driving-mode switch.

The HCU 100 acquires operation information indicating the content of the user operation from the CID 22, the operation device 26, and the like. The HCU 100 provides the automated driving ECU 50 with operation information about a user operation related to the automated driving function. The HCU 100 provides the navigation ECU 38 with operation information about a user operation for setting a destination of the subject vehicle Am.

### (Configuration of Automated Driving ECU)

The automated driving ECU 50 is a computer mainly including a control circuit including a processing section 51, a RAM 52, a storage section 53, an input/output interface 54, a bus connecting these, and the like. The processing section 51 executes various processes (instructions) for realizing the automated driving control method of the present disclosure by accessing the RAM 52. The storage section 53 stores various programs (automated driving control programs and the like) executed by the processing section 51. By execution of the program by the processing section 51, in the automated driving ECU 50, an information linkage section 61, an environment recognition section 62, an action determination section 63, a control execution section 64, a device control section 65, and the like are constructed as a plurality of function sections for realizing the automated driving function (see FIG. 2). The information linkage section may be referred to as an information cooperation section. The action determination section may be referred to as a behavior determination section.

The information linkage section 61 provides information to the HCU 100 and acquires information from the HCU 100 and the driver monitor 29. The information linkage section 61 acquires control state information indicating an operation state of the automated driving function from the action determination section 63, and provides the acquired control state information to the HCU 100. The control state information includes information indicating the automated driving level of the automated driving function in the operation state. The information linkage section 61 includes an HMI information acquisition section 71 and a notification request section 72 as sub-function sections for information linkage with the HCU 100 and the driver monitor 29.

The HMI information acquisition section 71 grasps the content of the user operation input to the CID 22, the operation device 26, and the like by the driver and the like based on the operation information acquired from the HCU 100. The HMI information acquisition section 71 grasps, for example, a Level 2 transition operation for instructing a transition from manual driving to driving assistance control, a Level 3 transition operation for instructing a transition from driving assistance control to autonomous travel control, and the like. Further, the HMI information acquisition section 71 grasps the action of the driver based on the driver status information acquired from driver monitor 29. The HMI information acquisition section 71 continuously grasps the driving posture, the line-of-sight direction, whether the surroundings monitoring is performed, whether the second task is performed, the degree of awakening, and the like of the driver during the traveling period by the driving assistance control or the autonomous travel control.

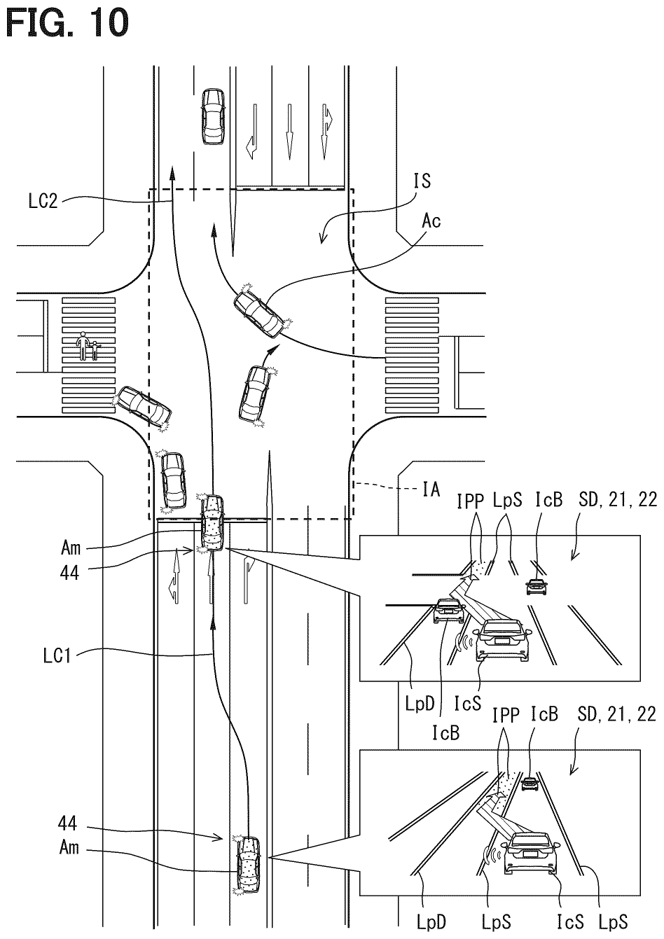

The notification request section 72 enables notification by the HCU 100 synchronized with the operation state of the automated driving function by outputting the notification execution request to the HCU 100. For example, in a case where the termination of the autonomous travel control is scheduled, the notification request section 72 outputs an execution request for a notification of requesting a driving-mode switch to the HCU 100. The notification request section 72 outputs, to the HCU 100, a request for execution of the notification related to the automated lane change by the driving assistance control or the autonomous travel control (see a status display SD in FIG. 10). Based on the notification request acquired from the notification request section 72, the HCU 100 makes a notification in which virtual image display or screen display by the display device, reproduction of a notification sound or message by the audio device 24, ambient display by the ambient light 25, and the like are appropriately combined.

The environment recognition section 62 combines the locator information and the map data acquired from the locator 35 with the detection information acquired from the surroundings monitoring sensor 30 to recognize the travel environment of the subject vehicle Am. The environment recognition section 62 can use the detection information received by the in-vehicle communication device 39 for recognition of the travel environment. The environment recognition section 62 acquires route information from the navigation ECU 38 and provides the acquired route information to the action determination section 63. The environment recognition section 62 acquires, from communication bus 99, vehicle speed information indicating a current traveling speed as information indicating a state of subject vehicle Am. The environment recognition section 62 includes an another vehicle grasping section 73 and a road grasping section 74 as sub-function sections for travel environment recognition. The road grasping section may be referred to as a road information grasp section.

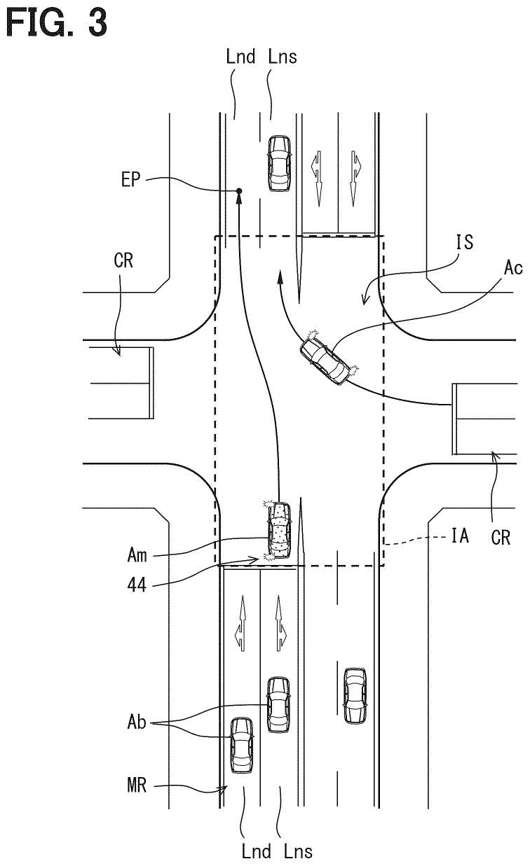

The another vehicle grasping section 73 grasps a relative position, a relative speed, and the like of a dynamic target around the subject vehicle, such as another vehicle traveling around the subject vehicle Am. The another vehicle grasping section 73 grasps the presence or absence, the relative position, the relative speed, and the like of the preceding vehicle (see an entry vehicle Ac in FIG. 3), the side vehicle, and the following vehicle Ab (see FIG. 3) of the subject vehicle Am in a scene where an automated lane change to be described later is performed. The another vehicle grasping section 73 determines whether there is a space where the subject vehicle Am can move in the adjacent lane Lnd (see FIG. 3).

The road grasping section 74 acquires information related to a road on which the subject vehicle Am travels or a road on which the subject vehicle Am is scheduled to travel. Specifically, in a case where the subject vehicle Am is traveling on a road including a plurality of lanes, the road grasping section 74 identifies the position of the subject vehicle lane Lns (see FIG. 3) on which the subject vehicle Am travels. In addition, the road grasping section 74 acquires route information acquired from the navigation ECU 38 and identifies a lane on which the subject vehicle Am should travel among the plurality of lanes.

The road grasping section 74 grasps whether the road on which the subject vehicle Am travels or the road on which the subject vehicle Am is scheduled to travel is within a preset permitted area. In the permitted area, the execution of the autonomous travel control at Level 3 or higher is permitted. The condition as to whether the area is a permitted area corresponds to a road condition in an operational design domain. The operational design domain is a unique condition related to a design travel environment that is a premise on which the automated driving ECU 50 normally operates, and is set according to the ability of the automated driving ECU 50. The information indicating whether the area is a permitted area may be recorded in map data stored in the map DB 36 or may be included in reception information received by the in-vehicle communication device 39. For example, an expressway, an automobile exclusive road, a specific general road maintained so as to enable automated driving, and the like are set as permitted areas.

In a case where the automated driving ECU 50 has the control right of the driving operation, the action determination section 63 generates a scheduled travel line on which the subject vehicle Am travels based on the recognition result of the travel environment by the environment recognition section 62 and the route information generated by the navigation ECU 38. The action determination section 63 outputs the generated scheduled travel line to the control execution section 64. The action determination section 63 includes the control switching section 75 as a sub-function section that controls the operation state of the automated driving function.

The control switching section 75 cooperates with the HCU 100 to control the driving-mode switch between the automated driving ECU 50 and the driver. The control switching section 75 switches between driving assistance control at Level 2 in which the driver is obliged to monitor the surroundings and autonomous travel control at Level 3 or higher in which the driver is not obliged to monitor the surroundings. The control switching section 75 permits the execution of automated driving at Level 3 or higher on roads within the permitted area, and permits only the execution automated driving at Level 2 on roads outside the permitted area. Further, the control switching section 75 performs switching between the automated driving at Level 3 and the automated driving at Level 4 or Level 5 in the autonomous travel control without the surroundings monitoring obligation. The control switching section 75 generates control state information indicating a current operation state of the automated driving function, and provides the generated control state information to the information linkage section 61 or the like.

In a case where the automated driving ECU 50 has the control right of the driving operation, the control execution section 64 executes acceleration/deceleration control, steering control, and the like of the subject vehicle Am in accordance with the scheduled travel line generated by the action determination section 63 in cooperation with the travel control ECU 40. Specifically, the control execution section 64 generates a control command based on the scheduled travel line, and sequentially outputs the generated control command to the travel control ECU 40.

The device control section 65 controls the start and termination of the blinking operation of the direction indicator 44 by outputting a control command to the body ECU 43. The device control section 65 performs the blinking operation of the direction indicator 44 close to the adjacent lane Lnd in cooperation with the body ECU 43 in accordance with the execution of the automated lane change by the driving assistance control or the autonomous travel control (see FIG. 3).

### (Automated Lane Change in Intersection)

In the automated driving ECU 50 described above, a travel control section 76 is provided in the action determination section 63 as a sub-function section. When determining that the space where the subject vehicle Am can move is in the adjacent lane Lnd, the travel control section 76 executes the automated lane change from the subject vehicle lane Lns to the adjacent lane Lnd. The travel control section 76 makes the automated lane change, for example, in a scene of overtaking another vehicle ahead that is slow, a scene of moving to a specific lane to go to a destination, and the like. The travel control section 76 can perform the automated lane change not only in a straight section of an expressway and a general road, but also in a section including the intersection IS of the general road (see FIG. 3).

Specifically, at some intersections IS, a lane change in the intersection IS is legally permitted. As an example, in a case where the section line (lane boundary line) drawn on the road surface immediately before the intersection IS is orange, the lane change in the section including the intersection IS is prohibited. On the other hand, in a case where the section line drawn on the road surface immediately before the intersection IS is white, the lane change in the section including the intersection IS can be performed.

Hereinafter, details of a plurality of scenes in which the automated lane change to the direction in which the subject vehicle leaves the subject vehicle lane Lns is performed at the intersection IS where the lane change is not legally prohibited will be described with reference to FIGS. 1 and 2 based on FIGS. 3 to 10.

### (Scene 1: Left Lane Change Scene for Avoiding Right-Turn Entry Vehicle)

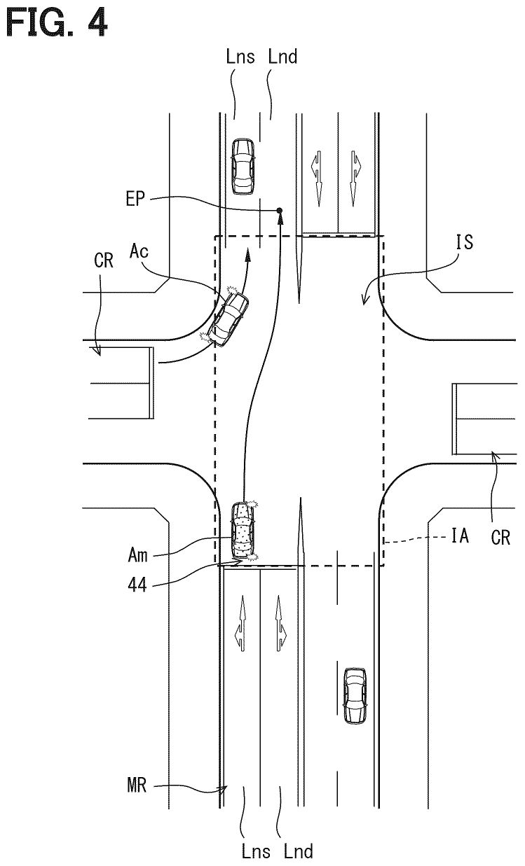

As illustrated in FIG. 3, in a scene where the subject vehicle Am enters intersection IS, the environment recognition section 62 grasps the presence of another vehicle located around subject vehicle Am, specifically, the following vehicle Ab and the entry vehicle Ac. The following vehicle Ab is a parallelly traveling vehicle that travels in the subject vehicle lane Lns and the adjacent lane Lnd behind the subject vehicle Am. The entry vehicle Ac is another vehicle that enters the subject vehicle lane Lns or the adjacent lane Lnd from the left or right intersecting road CR, and is a cut-in vehicle that enters the intersection IS in a direction intersecting the subject vehicle Am (see also FIG. 4).

The environment recognition section 62 grasps the relative position, the moving direction, the moving speed, and the like of the following vehicle Ab and the entry vehicle Ac based on the detection information. In addition, the environment recognition section 62 grasps the operation states of the direction indicators of the entry vehicle Ac and the following vehicle Ab located around the subject vehicle Am. The operation state of the direction indicators is behavior prediction information for predicting the future behavior of the entry vehicle Ac and the following vehicle Ab in the left-right direction. Based on the behavior prediction information, the environment recognition section 62 predicts in advance the entry of the entry vehicle Ac from the left intersecting road CR to the adjacent lane Lnd, the lane change of the following vehicle Ab from the subject vehicle lane Lns to the adjacent lane Lnd, and the like.

The environment recognition section 62 grasps whether there is a space for the subject vehicle Am in the subject vehicle lane Lns ahead of the intersection IS in a scene where the subject vehicle Am is scheduled to pass through the intersection IS. Specifically, the environment recognition section 62 sets a space between a pair of stop lines provided before and after the intersection IS as the intersection area IA (see a range of a broken line in FIG. 3). In a case where the subject vehicle Am cannot leave the intersection area IA, the environment recognition section 62 determines that there is no space for the subject vehicle Am in the subject vehicle lane Lns.

In the scene 1 illustrated in FIG. 3, the right lane of the two lanes of the arterial road MR is the subject vehicle lane Lns. In the scene 1, the subject vehicle lane Lns ahead of the intersection area IA is jammed (congested), and the entry vehicle Ac is entering the subject vehicle lane Lns by turning right from the right intersecting road CR of the intersection IS. Therefore, the environment recognition section 62 determines that there is no space in the subject vehicle lane Lns ahead of the intersection IS after the subject vehicle Am enters the intersection IS (intersection area IA) beyond the stop line before the intersection. On the other hand, the environment recognition section 62 determines that there is a space for the subject vehicle Am ahead of the intersection IS in the case of the adjacent lane Lnd.

In a case where there is no space in the subject vehicle lane Lns and there is a space in the adjacent lane Lnd, the travel control section 76 determines execution of the automated lane change to the direction (the left direction in FIG. 3) in which the subject vehicle leaves the subject vehicle lane Lns in the section including the intersection IS. In this case, the travel control section 76 determines whether there is a space where the subject vehicle Am can move in the adjacent lane Lnd using the information of the entry vehicle Ac and the following vehicle Ab recognized by the environment recognition section 62. In a case where there is no entry vehicle Ac entering the adjacent lane Lnd and the inter-vehicle distance between the following vehicle Ab traveling in the adjacent lane Lnd and the subject vehicle Am exceeds the minimum inter-vehicle distance, the travel control section 76 starts the automated lane change. The device control section 65 starts blinking the direction indicator 44 corresponding to the moving direction in the automated lane change in the section including the intersection IS (hereinafter, in-intersection automated LC), as in the automated lane change in the section not including the intersection IS (hereinafter, out-of-intersection automated LC).

The travel control section 76 sets the minimum inter-vehicle distance for which the execution of the in-intersection automated LC is permitted to be short, compared with the minimum inter-vehicle distance for which the execution of the out-of-intersection automated LC is permitted. In addition, the travel control section 76 sets the lower limit speed at which execution of the in-intersection automated LC is permitted to be low, compared with the lower limit speed at which execution of the out-of-intersection automated LC is permitted. As an example, the travel control section 76 sets the lower limit speed to 0 km/h so that the automated lane change can be made even from the stopped state. As a result, the travel control section 76 performs the in-intersection automated LC at a low speed, compared with the out-of-intersection automated LC.

The travel control section 76 sets a completion point EP of the in-intersection automated LC ahead of the intersection IS. The travel control section 76 makes the lateral (left-right direction) vector generated in the subject vehicle Am in the in-intersection automated LC small, compared with the lateral vector in the out-of-intersection automated LC. The vector indicates the direction and magnitude of the acceleration acting on the subject vehicle Am by the automated lane change. In a case where the traveling speed of the subject vehicle Am is the same, the acceleration in the lateral direction generated in the in-intersection automated LC is suppressed, compared with the acceleration in the lateral direction generated in the out-of-intersection automated LC. As a result, the entry angle of the subject vehicle Am when entering the adjacent lane Lnd is gentle (small) in the in-intersection automated LC, compared with in the out-of-intersection automated LC. As described above, in the in-intersection automated LC, since it is first important to exit from the intersection area IA, the movement in the forward direction is prioritized over the movement in the laterally backward direction.

### (Scene 2: Right Lane Change Scene for Avoiding Left-Turn Entry Vehicle)

In the scene 2 illustrated in FIG. 4, the left lane of the two lanes of the arterial road MR is the subject vehicle lane Lns. In the scene 2, the subject vehicle lane Lns ahead of the intersection area IA is jammed (congested), and the entry vehicle Ac enters the subject vehicle lane Lns by turning left from the left intersecting road CR of the intersection IS. The environment recognition section 62 determines that there is no space for the subject vehicle Am in the subject vehicle lane Lns ahead of the intersection IS due to the entry of the entry vehicle Ac, and determines that there is a space for the subject vehicle Am in the adjacent lane Lnd ahead of the intersection IS.

In a case where there is no space in the subject vehicle lane Lns and there is a space in the adjacent lane Lnd, the travel control section 76 determines execution of the automated lane change to the direction (the right direction in FIG. 4) in which the subject vehicle leaves the subject vehicle lane Lns in the section including the intersection IS. When it is confirmed that there is no entry vehicle Ac entering the adjacent lane Lnd from the right intersecting road CR and there is no following vehicle Ab in the adjacent lane Lnd, the travel control section 76 starts the automated lane change. Also in the in-intersection automated LC in the right direction, the travel control section 76 sets the completion point EP ahead of the intersection IS.

The travel control section 76 changes the traveling speed of the subject vehicle Am according to the left and right moving directions in the in-intersection automated LC. In a case where the other conditions are the same, the travel control section 76 sets the traveling speed of the in-intersection automated LC in the right direction to be higher (larger) than that of the in-intersection automated LC in the left direction (see FIG. 3). As an example, the travel control section 76 slightly accelerates the subject vehicle Am in the case of the in-intersection automated LC in the right direction. On the other hand, in the case of the in-intersection automated LC in the left direction, the travel control section 76 maintains the traveling speed of the subject vehicle Am.

(Scene 3: Automated Lane Change Scene at Intersection with Traffic Signal)

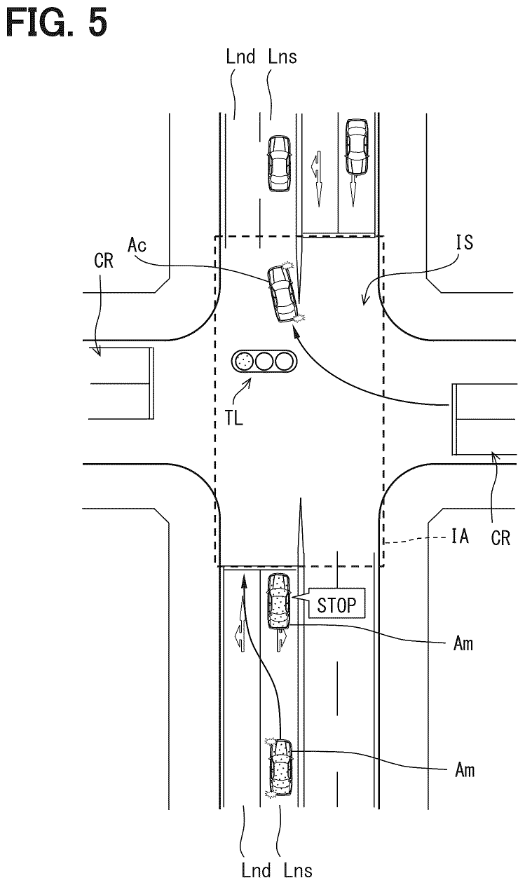

In the scene 3 illustrated in FIG. 5, the traffic signal TL is installed at the intersection IS. The environment recognition section 62 grasps at least the current lighting pattern (lighting state) of the traffic signal TL located in front of the subject vehicle Am among the plurality of traffic signals TL installed at the intersection IS. In a case where the traffic signal TL in front of the subject vehicle is in a lighting pattern (red light) instructing stop, the travel control section 76 stops the subject vehicle Am before the stop line.

The environment recognition section 62 further determines whether the subject vehicle Am has entered the intersection area IA at the intersection IS where the traffic signal TL is installed. In a case where it is determined that there is no space for the subject vehicle Am in the subject vehicle lane Lns ahead of the intersection IS after the subject vehicle Am enters the intersection area IA, the travel control section 76 determines execution of the in-intersection automated LC (see FIG. 3).

On the other hand, in a case where it is determined that there is no space for the subject vehicle Am in the subject vehicle lane Lns ahead of the intersection IS before the subject vehicle Am enters the intersection area IA, the travel control section 76 suspends execution of the in-intersection automated LC. In this case, the travel control section 76 stops the subject vehicle Am before the stop line (intersection area IA) even if the traffic signal TL is in a lighting pattern (green light) for permitting traveling.

Furthermore, in a case where the environment recognition section 62 grasps at an early stage that there is no space for the subject vehicle Am in the subject vehicle lane Lns ahead of the intersection IS, the travel control section 76 determines whether the out-of-intersection automated LC can be completed before the intersection area IA. In a case where it is determined that the out-of-intersection automated LC can be completed before the intersection area IA, the travel control section 76 performs the out-of-intersection automated LC and moves the subject vehicle Am to the adjacent lane Lnd before entering the intersection area IA. In a case where it is grasped at an early stage that there is no space for the subject vehicle Am ahead of the intersection IS even at the intersection IS without the traffic signal TL, the travel control section 76 moves the subject vehicle Am to the adjacent lane Lnd by the out-of-intersection automated LC before entering the intersection area IA.

Here, the travel control section 76 makes it easier to determine execution of the in-intersection automated LC at the intersection IS (see FIG. 3) where the traffic signal TL is not installed, compared with at the intersection IS where the traffic signal TL is installed. That is, the in-intersection automated LC is performed preferentially at the intersection IS where the traffic signal TL is not set, compared with at the intersection IS where the traffic signal TL is installed. As an example, at the intersection IS where the traffic signal TL is not installed, even in a case where it is determined that there is no space in the subject vehicle lane Lns immediately before entering the intersection area IA, the travel control section 76 determines execution of the in-intersection automated LC without stopping the subject vehicle Am on the stop line.

(Scene 4: Automated Lane Change Scene at Intersection where Pedestrian is Present)

In the scene 4 illustrated in FIG. 6, the crosswalk PC is provided at the intersection IS. In the waiting area WA facing the intersection IS, there is a pedestrian Pd who is about to cross the crosswalk PC. The environment recognition section 62 determines whether the crosswalk PC is provided at the intersection IS and whether the pedestrian Pd is present in the waiting area WA.

The travel control section 76 suppresses the traveling speed of the subject vehicle Am in the in-intersection automated LC and performs the lateral movement at a low speed in a case where the pedestrian Pd is present in the waiting area WA, compared with in a case where the pedestrian Pd is not present in the waiting area WA. The travel control section 76 makes the lateral vector generated in the subject vehicle Am in the automated lane change in which the subject vehicle Am approaches the pedestrian Pd (left side in FIG. 6) small, compared with the lateral vector in the automated lane change in which the subject vehicle Am is away from the pedestrian Pd (right side in FIG. 6).

In a case where the pedestrian Pd is present in the waiting area WA, the travel control section 76 completes the in-intersection automated LC in the intersection area IA. In addition, in a case where the crosswalk PC is provided at the intersection IS, the travel control section 76 sets the completion point EP of the in-intersection automated LC before the crosswalk PC. As a result, the travel control section 76 does not perform the in-intersection automated LC of crossing the lane on the crosswalk PC.

In a case where there is a pedestrian Pd who is scheduled to cross the crosswalk PC, the travel control section 76 completes the in-intersection automated LC before the crosswalk PC, and then causes the subject vehicle Am to wait (temporarily stop) at the position before the crosswalk PC. When the environment recognition section 62 grasps that the pedestrian Pd crossing the crosswalk PC has passed in front of the subject vehicle Am, the travel control section 76 starts the subject vehicle Am.

### (Scene 5: Scene of Avoidance of Emergency Vehicle)

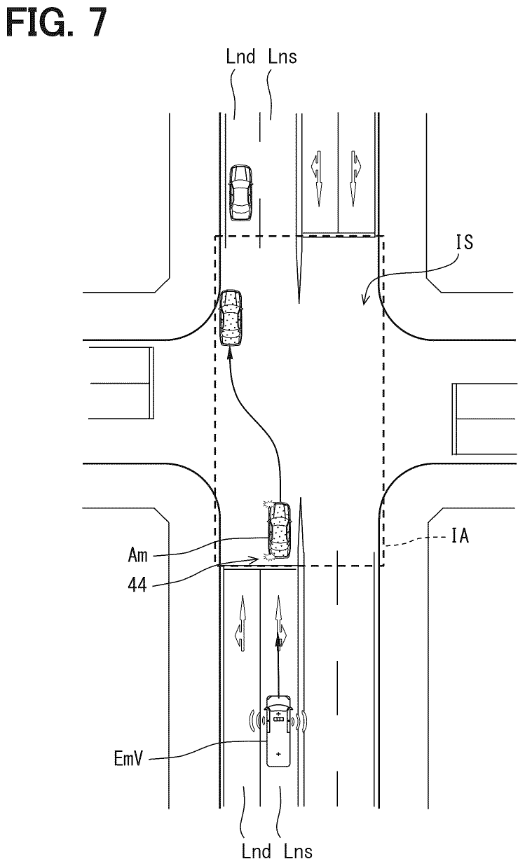

In the scene 5 illustrated in FIG. 7, an emergency vehicle EmV is approaching from behind the subject vehicle Am. The emergency vehicle EmV is a police vehicle such as a patrol car, a fire engine, and an ambulance. The environment recognition section 62 recognizes the emergency vehicle EmV approaching the subject vehicle Am from behind based on the detection information. In a case of recognizing the emergency vehicle EmV, the environment recognition section 62 further grasps whether the subject vehicle Am is located on the expected course of the emergency vehicle EmV, in other words, whether the emergency vehicle EmV is traveling in the subject vehicle lane Lns. The subject vehicle Am may further be provided with an acoustic sensor (for example, a microphone or the like) for detecting a siren of the emergency vehicle EmV as the surroundings monitoring sensor 30.

In a scene where the subject vehicle Am is scheduled to pass through the intersection IS, in a case where the emergency vehicle EmV is approaching from behind and the subject vehicle Am is traveling on an expected course of the emergency vehicle EmV, the travel control section 76 determines execution of the in-intersection automated LC. The travel control section 76 moves the subject vehicle Am in a direction in which the subject vehicle leaves the expected course of the emergency vehicle EmV (in FIG. 7, the left direction) by the in-intersection automated LC. In a case where there is not the space for the subject vehicle Am in the adjacent lane Lnd ahead of the intersection area IA, the travel control section 76 stops the subject vehicle Am by moving to the road shoulder in the intersection area IA. Thus, a traveling space for the emergency vehicle EmV is secured.

### (Scene 6: Standby Scene of Automated Lane Change in Intersection)

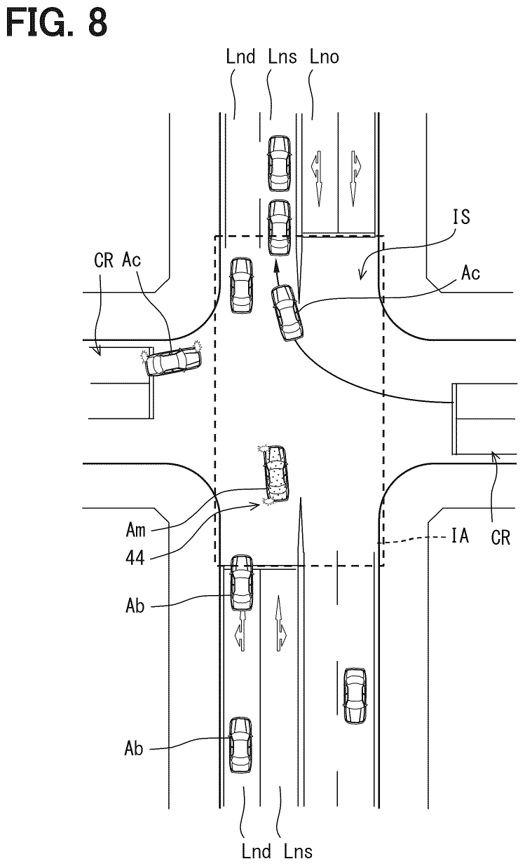

In the scene 6 illustrated in FIG. 8, the in-intersection automated LC is in a standby state due to the presence of the entry vehicle Ac and the following vehicle Ab. Even in a case where the in-intersection automated LC is in the standby state, the device control section 65 continues blinking of the moving side direction indicator 44 (left side in FIG. 8). After execution of the in-intersection automated LC is decided, the travel control section 76 times out the in-intersection automated LC in a case where the duration of the standby state exceeds the upper limit standby time.

In a case where the in-intersection automated LC is timed out in the intersection area IA, the control switching section 75 performs the driving-mode switch from the automated driving system to the driver. In a case where the in-intersection automated LC is timed out in the intersection area IA, the travel control section 76 may cause the subject vehicle Am to leave the intersection IS by a right or left turn in a direction in which the subject vehicle deviates from the scheduled travel route set in the navigation ECU 38. In this case, an emergency right or left turn is made in a direction different from the traveling direction facing the occupant of the subject vehicle Am.

In a case where it is determined that there is no space for the subject vehicle Am in the subject vehicle lane Lns ahead of the intersection IS, the environment recognition section 62 estimates whether the congestion of the subject vehicle lane Lns ahead of the intersection IS continues. The travel control section 76 changes the standby posture of the subject vehicle Am in the intersection area IA according to the estimation result of whether the congestion ahead of the intersection area IA continues.

Specifically, in a case where the in-intersection automated LC is in the standby state in the intersection area IA and it is estimated that the congestion of the subject vehicle lane Lns continues, the travel control section 76 stops the subject vehicle Am in the inclined posture in which subject vehicle moves toward the moving side (left side in FIG. 7) in the in-intersection automated LC. In this case, the subject vehicle Am waits in a posture prioritizing the execution of the automated lane change while operating the direction indicator 44.

On the other hand, in a case where the in-intersection automated LC is in a standby state in the intersection area IA and the environment recognition section 62 estimates that the congestion does not continue, the travel control section 76 stops the subject vehicle Am in a straight posture along the subject vehicle lane Lns. When a space is generated in the subject vehicle lane Lns ahead of the intersection IS after the transition to the standby state, the device control section 65 stops the blinking operation of the direction indicator 44. The travel control section 76 causes the subject vehicle Am to travel straight toward the space ahead.

The travel control section 76 changes the upper limit standby time for timing out the automated lane change between the in-intersection automated LC and the out-of-intersection automated LC. The travel control section 76 sets the upper limit standby time in the in-intersection automated LC to be shorter than the upper limit standby time in the out-of-intersection automated LC. In addition, the travel control section 76 changes the upper limit standby time of the in-intersection automated LC according to whether the place in the standby state is in the intersection area IA. The travel control section 76 sets the upper limit standby time after entering the intersection IS to be shorter than the upper limit standby time before entering the intersection IS.

Further, the travel control section 76 changes the upper limit standby time of the in-intersection automated LC according to whether the traffic signal TL (see FIG. 5) is installed at the intersection IS. The travel control section 76 sets the upper limit standby time of the in-intersection automated LC to be longer at the intersection IS where the traffic signal TL is not installed than at the intersection IS where the traffic signal TL is installed. In the intersection IS where the traffic signal TL is not installed, the upper limit standby time may not be substantially set.

### (Scene 7: Execution Restriction Scene of Automated Lane Change)

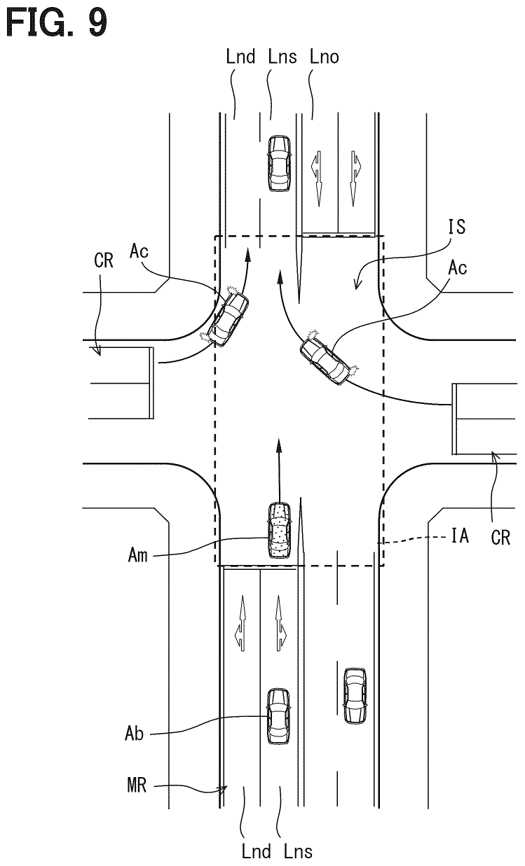

In the scene 7 illustrated in FIG. 9, the entry vehicle Ac enters an arterial road MR from the both left and right intersecting roads CR. More specifically, from the left intersecting road CR of the intersection IS, the entry vehicle Ac enters the adjacent lane Lnd by turning left. Further, from the right intersecting road CR of the intersection IS, the entry vehicle Ac enters the subject vehicle lane Lns by turning right. The environment recognition section 62 grasps these entry vehicles Ac entering the intersection IS in front of the subject vehicle Am.

In a case where the entry vehicles Ac are present on both left and right sides at the intersection IS, the travel control section 76 restricts execution of the in-intersection automated LC. In this case, the travel control section 76 does not perform the in-intersection automated LC. The travel control section 76 causes the subject vehicle Am to travel straight so that the subject vehicle Am follows the entry vehicle Ac entering the subject vehicle lane Lns.

Furthermore, the travel control section 76 restricts execution of the in-intersection automated LC according to the travel environment around the subject vehicle. Hereinafter, details of each scene in which execution of the in-intersection automated LC is restricted will be described.

The environment recognition section 62 determines whether the surroundings of the subject vehicle Am are in bad weather based on the detection information of the camera unit 31, the reception information of the in-vehicle communication device 39, and the like. As an example, in a case where there is a high possibility that the road surface at the intersection IS is frozen due to snowfall or snow falling accumulation, the environment recognition section 62 determines that the surroundings of the subject vehicle Am is bad weather. In this case, the travel control section 76 restricts execution of the in-intersection automated LC, and specifically, does not perform the in-intersection automated LC.

The environment recognition section 62 grasps the scale of the intersection IS through which the subject vehicle Am is scheduled to pass. The environment recognition section 62 determines the scale of the intersection IS based on the area of the intersection area IA. In a case where the number of lanes of the arterial road MR and the intersecting road CR intersecting at the intersection IS is larger than a predetermined number, the environment recognition section 62 determines that the scale of the most recent intersection IS is large. In addition, in a case where the intersection IS is a multi-way intersection (five or more way intersection), the environment recognition section 62 determines that the scale of the most recent intersection IS is large. The travel control section 76 changes a determination criterion as to whether to permit the in-intersection automated LC according to the scale of the intersection IS. Specifically, the travel control section 76 makes the determination criterion stricter for the intersection IS determined to be larger in scale by the environment recognition section 62, and does not perform the in-intersection automated LC.

In a case of grasping the entry vehicle Ac entering the subject vehicle lane Lns, the environment recognition section 62 determines whether the priority of the intersecting road CR is higher than the priority of the subject vehicle road on which the subject vehicle Am travels. The environment recognition section 62 may determine the priority relationship between the intersecting road CR and the subject vehicle road with reference to the map data, or may determine the priority relationship based on information about a road width and the like grasped by the camera unit 31. In a case where the priority of the subject vehicle road (arterial road MR) is higher than the priority of the intersecting road CR, the travel control section 76 permits the execution of the in-intersection automated LC. On the other hand, in a case where the priority of the intersecting road CR is higher than the priority of the subject vehicle road, the travel control section 76 restricts execution of the in-intersection automated LC, specifically, does not perform the in-intersection automated LC.

The environment recognition section 62 grasps the scheduled travel route of the subject vehicle Am set in the automated driving function based on the route information acquired from the navigation ECU 38. Even in a case where there is no space in the subject vehicle lane Lns ahead of the intersection IS, the travel control section 76 restricts execution of the in-intersection automated LC in a direction in which the subject vehicle Am deviates from the scheduled travel route. As an example, in a case where it is necessary to enter a right turn lane at the next intersection IS after passing through the most recent intersection IS, the travel control section 76 does not perform the in-intersection automated LC to the left at the most recent intersection IS. As another example, in a case where it is necessary to avoid the right-turn dedicated lane at the next intersection IS that has passed through the most recent intersection IS, the travel control section 76 does not perform the in-intersection automated LC to the right at the most recent intersection IS.

### (Scene 8: Continuous Implementation Scene of Automated Lane Change)

In the scene 8 illustrated in FIG. 10, the out-of-intersection automated LC (first lane change LC1) and the in-intersection automated LC (second lane change LC2) are continuously performed. In a case where the first lane change LC1 and the second lane change LC2 are continuously performed by the travel control section 76, the device control section 65 continues the blinking operation of the direction indicator 44 of the subject vehicle Am. The blinking operation of the direction indicator 44 is continued from before the start of the first lane change LC1 to after the termination of the second lane change LC2.

In a case where the first lane change LC1 and the second lane change LC2 are continuously performed by the travel control section 76, the notification request section 72 cooperates with the HMI system 10 to make a notification that the first lane change LC1 has shifted to the second lane change LC2. The transition from the first lane change LC1 to the second lane change LC2 is notified by the status display SD displayed on, for example, the meter display 21 or the CID 22. The status display SD includes a subject vehicle icon IcS, an another vehicle icon IcB, lane icon images LpS and LpD, and an LC icon IPP. The status display SD makes a notification of the transition from the first lane change LC1 to the second lane change LC2 by changing the display color of an LC icon IPP between the first lane change LC1 and the second lane change LC2. The status display SD may make a notification of the transition from the first lane change LC1 to the second lane change LC2 by temporarily hiding and then redisplaying the LC icon IPP.

### (Details of Execution Determination Process and Lane Change Control Process)

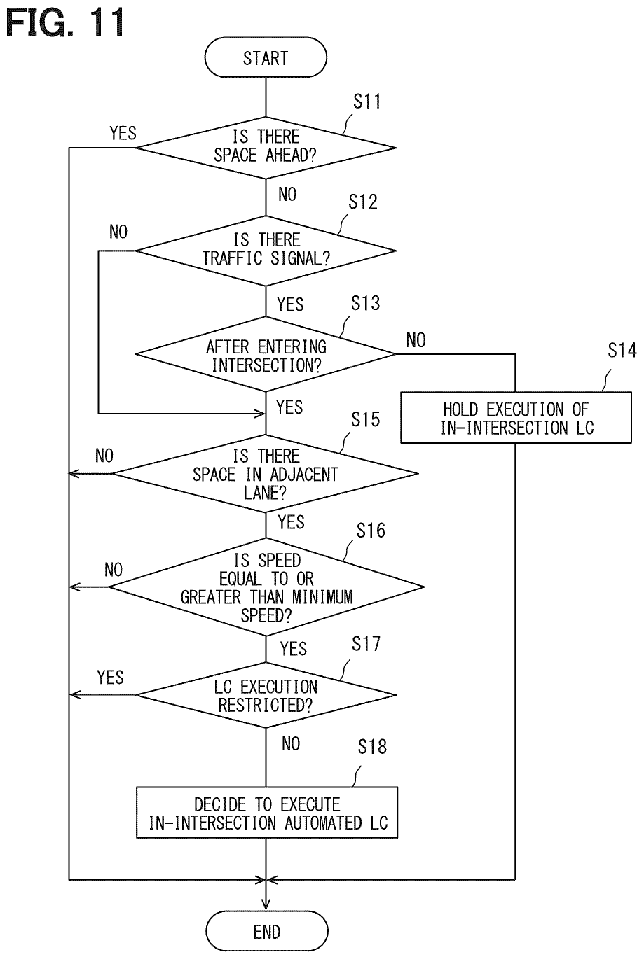

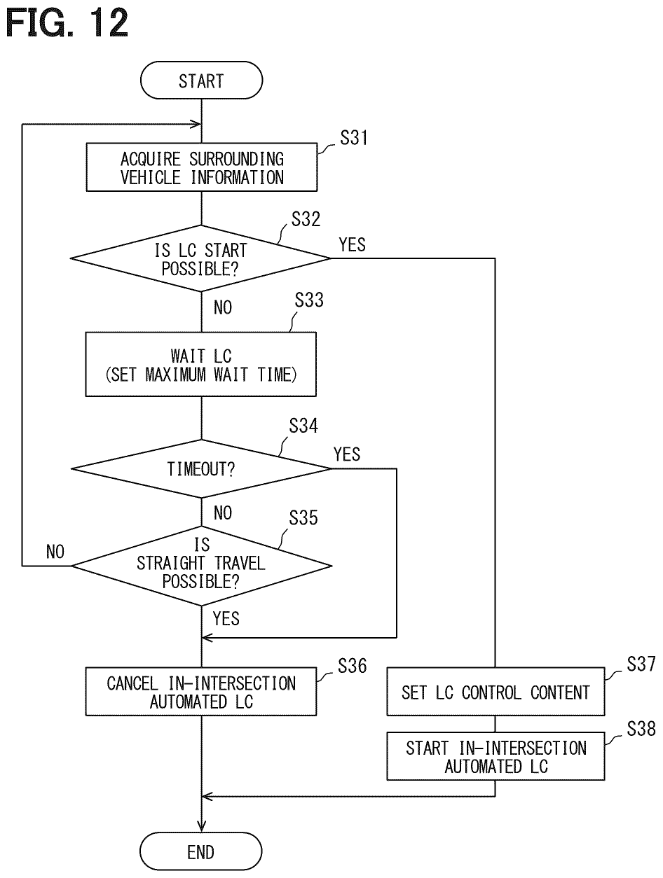

Next, details of the execution determination process and the lane change control process executed by the automated driving ECU 50 in order to realize the above-described in-intersection automated LC will be described below with reference to FIGS. 1 to 10 based on FIGS. 11 and 12.

The execution determination process illustrated in FIG. 11 is started by the automated driving ECU 50 on condition that the subject vehicle Am approaches the intersection area IA by a predetermined distance (for example, about 1 km). The execution determination process is continuously performed until the subject vehicle passes through the intersection area IA, and is terminated after the subject vehicle passes through the intersection area IA.

In S11 of the execution determination process, the environment recognition section 62 determines whether there is a space for the subject vehicle Am in the subject vehicle lane Lns ahead of the intersection IS. In a case where there is a space in the subject vehicle lane Lns ahead of the intersection IS (S11: YES), the execution determination process is temporarily terminated. On the other hand, in a case where there is no space in the subject vehicle lane Lns ahead of the intersection IS (S11: NO), the environment recognition section 62 grasps whether the traffic signal TL is installed at the intersection IS in S12. In a case where the traffic signal TL is installed at the intersection IS (S12: YES), the environment recognition section 62 determines whether the subject vehicle Am has entered the intersection area IA in S13.

In a case where it is determined that there is no space in the subject vehicle lane Lns before the subject vehicle Am enters the intersection area IA (S13: NO), the travel control section 76 suspends execution of the in-intersection automated LC in S14 and stops the subject vehicle Am before the intersection area IA (stop line). In S14, the travel control section 76 may attempt the in-intersection automated LC by slowly moving the subject vehicle Am straight without stopping on the stop line.

In a case where the traffic signal TL is not installed at the intersection IS (S12: NO), or in a case where it is determined that there is no space ahead after the subject vehicle Am enters the intersection area IA (S13: YES), the environment recognition section 62 grasps the situation of the adjacent lane Lnd in S15. In S15, the environment recognition section 62 determines whether there is a space for the subject vehicle Am in the adjacent lane Lnd ahead of the intersection IS. In a case where there is no space in the adjacent lane Lnd (S15: NO), the execution determination process is temporarily terminated.

In a case where there is a space in the adjacent lane Lnd (S15: YES), the travel control section 76 determines in S16 whether the current traveling speed of the subject vehicle Am is equal to or higher than the lower limit speed at which execution of the in-intersection automated LC is permitted. In a case where the traveling speed of the subject vehicle Am is less than the lower limit speed (S16: NO), the execution determination process is temporarily terminated. On the other hand, in a case where the traveling speed of the subject vehicle Am is equal to or higher than the lower limit speed (S16: YES), the travel control section 76 determines whether execution of the in-intersection automated LC is restricted for the most recent intersection IS in S17.

In a case where the section lines before and after the intersection IS are orange, the travel control section 76 determines that the in-intersection automated LC is not legally permitted, and determines not to perform the in-intersection automated LC. In addition, in a case where the environment recognition section 62 grasps the entry vehicles Ac on both the left and right sides, in a case where the bad weather around the subject vehicle is grasped, and in a case where it is determined that the most recent intersection IS is the large-scale intersection IS, the travel control section 76 determines not to perform the in-intersection automated LC. Furthermore, in a case where the environment recognition section 62 determines that the priority of the subject vehicle road is lower than the priority of the intersecting road CR, and in a case where it is determined that the vehicle deviates from the scheduled travel route when the in-intersection automated LC is performed, the travel control section 76 determines not to perform the in-intersection automated LC.

In a case where the execution of the in-intersection automated LC is restricted at the most recent intersection IS (S17: YES), the execution determination process is temporarily terminated. On the other hand, in a case where the execution of the in-intersection automated LC is not restricted at the most recent intersection IS (S17: NO), the travel control section 76 determines, in S18, the execution of the automated lane change to the direction in which the subject vehicle leaves the subject vehicle lane Lns in the section including the intersection IS.

The lane change control process illustrated in FIG. 12 is started by the automated driving ECU 50 based on the determination of the execution of the in-intersection automated LC by the execution determination process. In S31 of the lane change control process, the environment recognition section 62 acquires information about the following vehicle Ab and the entry vehicle Ac located around the subject vehicle Am. In S31, the operation information about the direction indicators of these other vehicles is grasped as the behavior prediction information.

In S32, the travel control section 76 determines whether the in-intersection automated LC can be started. In a case where the following vehicle Ab is not present in the adjacent lane Lnd or in a case where the minimum inter-vehicle distance is secured for the following vehicle Ab, the travel control section 76 determines that the in-intersection automated LC can be started on condition that there is no entry vehicle Ac entering the adjacent lane Lnd. In a case where it is determined that the in-intersection automated LC can be started (S32: YES), the travel control section 76 sets control content of the in-intersection automated LC in S37. In S38, after the device control section 65 starts the blinking operation of the direction indicator 44, the travel control section 76 starts the in-intersection automated LC.

Here, in S37, the traveling speed of the subject vehicle Am is changed according to the left and right moving directions in the in-intersection automated LC. Further, in S37, the traveling speed of the subject vehicle Am is changed according to whether the pedestrian Pd is present in the waiting area WA and whether the subject vehicle Am moves in the direction in which the subject vehicle Am approaches the pedestrian Pd by the in-intersection automated LC. Further, in S37, the completion point EP of the in-intersection automated LC is changed according to the presence or absence of the crosswalk PC and the pedestrian Pd.

On the other hand, in a case where it is determined that the in-intersection automated LC cannot be started (S32: NO), the travel control section 76 puts the in-intersection automated LC into a standby state in S33. In S33, an upper limit standby time for determining a timeout of the in-intersection automated LC is set. In S34, the travel control section 76 determines the timeout of the in-intersection automated LC based on whether the duration time of the standby state exceeds the upper limit standby time. In a case where the in-intersection automated LC is timed out (S34: YES), the travel control section 76 determines to suspend the in-intersection automated LC in S36. In this case, a driving-mode switch to a driver, switching to straight traveling, switching to right or left turning in a direction different from the scheduled travel route, and the like are performed.

In addition, in a case where the in-intersection automated LC is not timed out (S34: NO), the travel control section 76 determines whether straight traveling has become possible in S35. In a case where a space is generated in the subject vehicle lane Lns ahead of the intersection IS, the travel control section 76 determines that it is possible to travel straight (S35: YES). In this case, in S36, the travel control section 76 determines to suspend the in-intersection automated LC, and causes the subject vehicle Am to travel straight toward the space generated in the subject vehicle lane Lns. On the other hand, in a case where there is not the space in the subject vehicle lane Lns ahead of the intersection IS (S35: NO), the travel control section 76 continues the standby state of the in-intersection automated LC.

### Overview of First Embodiment

In the first embodiment described so far, even in a case where there is no space for the subject vehicle Am in the subject vehicle lane Lns ahead of the intersection IS, the subject vehicle Am can be caused to leave the intersection IS by changing the traveling lane by the automated lane change in the section including the intersection IS. Therefore, a situation in which the subject vehicle Am stays in the intersection IS is not likely to occur. As a result, the convenience of the automated driving can be secured.

In addition, in the first embodiment, it is determined whether the subject vehicle Am has entered the intersection IS based on the positional relationship between the subject vehicle Am and the intersection area IA. In a case where it is determined that there is no space in the subject vehicle lane Lns after the entry into the intersection IS, the travel control section 76 determines execution of the in-intersection automated LC. As a result, the travel control section 76 can perform the in-intersection automated LC in a scene where the subject vehicle Am is likely to stay in the intersection IS, and can avoid occurrence of stay in advance. In addition, in a case where it is determined that there is no space in the subject vehicle lane Lns before entering the intersection IS, the travel control section 76 suspends execution of the in-intersection automated LC. As a result, entry of the subject vehicle Am into the intersection area IA is suppressed, so that occurrence of stay in the intersection IS can be prevented in advance.

In the first embodiment, the traveling speed of the subject vehicle Am is changed according to the left and right moving directions in the in-intersection automated LC. Thus, the travel control section 76 can smoothly move the subject vehicle Am to the adjacent lane Lnd in the in-intersection automated LC.

Further, in the first embodiment, it is determined whether the pedestrian Pd is present in the waiting area WA facing the intersection IS. The travel control section 76 suppresses the traveling speed of the subject vehicle Am in the in-intersection automated LC in a case where the pedestrian Pd is present in the waiting area WA, compared with in a case where the pedestrian Pd is not present in the waiting area WA. Such adjustment of the traveling speed makes it difficult for the pedestrian Pd to feel uneasy about the subject vehicle Am that changes the lane in the intersection area IA.

In addition, in the first embodiment, it is determined whether the surroundings of the subject vehicle Am are in bad weather. In a case where the surroundings of the subject vehicle Am are in bad weather, the travel control section 76 restricts execution of the in-intersection automated LC. In the case of bad weather, the situation of the road surface in the intersection area IA is likely to be worse than the situation of the road surface outside the intersection area IA. Therefore, it is possible to cause the subject vehicle Am smoothly travel by suppressing execution of the in-intersection automated LC in bad weather.

In the first embodiment, the scale of the intersection IS through which the subject vehicle Am is scheduled to pass is grasped. The travel control section 76 changes a determination criterion as to whether to permit the in-intersection automated LC according to the scale of the intersection IS. Specifically, the travel control section 76 restricts execution of the in-intersection automated LC at the large-scale intersection IS. The larger the scale of the intersection IS, the more likely the travel environment is complicated, and the higher the difficulty level of changing the automated lane change is. Therefore, it is desirable that the execution of the in-intersection automated LC is restricted as the intersection IS is larger.

Further, in the first embodiment, the emergency vehicle EmV approaching the subject vehicle Am from behind is recognized. In a case where the emergency vehicle EmV is recognized, the travel control section 76 permits execution of a lane change in a direction in which the subject vehicle leaves the expected course of the emergency vehicle EmV in a section including the intersection IS. According to the above, it is possible to smoothly give way to the emergency vehicle EmV using the intersection area IA where a space is easily secured near the road shoulder.

In addition, in the first embodiment, it is grasped whether the traffic signal TL is installed at the intersection IS. The travel control section 76 makes it easier to determine execution of the in-intersection automated LC at the intersection IS where the traffic signal TL is not installed, compared with at the intersection IS where the traffic signal TL is installed. In the intersection IS where the traffic signal TL is not installed, even in a case where the in-intersection automated LC is in the standby state in the intersection area IA, the problem is less likely to occur. Therefore, the in-intersection automated LC is actively performed at the intersection IS without the traffic signal TL, whereby the convenience of the automated driving can be secured.

In the first embodiment, the lower limit speed at which execution of the in-intersection automated LC is permitted is set to be lower than the lower limit speed at which execution of the out-of-intersection automated LC is permitted. Therefore, even when the traveling speed of the subject vehicle Am decreases as the subject vehicle Am approaches the intersection IS, the travel control section 76 can determine execution of the in-intersection automated LC.

Furthermore, in the first embodiment, behavior prediction information is grasped to predict future behavior in the left-right direction of the following vehicle Ab and the entry vehicle Ac located around the subject vehicle Am. The travel control section 76 determines whether to start the in-intersection automated LC using the behavior prediction information. According to the above, the travel control section 76 can smoothly start the lane change even under a complicated travel environment such as the intersection area IA.

In addition, in the first embodiment, the minimum inter-vehicle distance for which the execution of the in-intersection automated LC is permitted is set to be shorter than the minimum inter-vehicle distance for which the execution of the out-of-intersection automated LC is permitted. According to the above, since the in-intersection automated LC is easily started, the situation of staying in the intersection IS can be more reliably avoided.

In the first embodiment, the lateral vector generated in the subject vehicle Am in the in-intersection automated LC is made smaller than the lateral vector in the out-of-intersection automated LC. According to the above, in the in-intersection automated LC, the forward movement is prioritized over the lateral movement. As a result, the travel control section 76 can quickly cause the subject vehicle Am to leave the intersection area IA while performing the in-intersection automated LC.

Further, in the first embodiment, the lateral vector, generated in the subject vehicle Am in the in-intersection automated LC, in which the subject vehicle approaches the pedestrian Pd in the waiting area WA is made smaller than the lateral vector, in the in-intersection automated LC, in which the subject vehicle is away from the pedestrian Pd. Such adjustment of the lateral vector makes it difficult for the pedestrian Pd to feel uneasy about the subject vehicle Am that changes the lane in the intersection area IA.

In addition, in the first embodiment, in a case where the pedestrian Pd is present in the waiting area WA, the travel control section 76 completes the in-intersection automated LC in the intersection area IA. Even by such adjustment of the automated lane change completion point EP, the pedestrian Pd is less likely to feel uneasy about the subject vehicle Am that executes the lane change in the intersection area IA.

Further, in the first embodiment, it is grasped whether a crosswalk PC is provided at the intersection IS. In a case where the crosswalk PC is provided at the intersection IS, the travel control section 76 completes the in-intersection automated LC before the crosswalk PC. According to the above, it is possible to prevent the occurrence of lateral movement such as crossing the lane on the crosswalk PC.

Furthermore, in the first embodiment, it is determined whether there is a pedestrian Pd scheduled to cross the crosswalk PC. In a case where the pedestrian Pd is present, the travel control section 76 completes the in-intersection automated LC before the crosswalk PC, and then causes the subject vehicle Am to wait in front to the crosswalk. According to the above, it is possible to smoothly prioritize crossing of the pedestrian Pd waiting for crossing.

In addition, in the first embodiment, the completion point EP of the in-intersection automated LC is set ahead of the intersection IS. According to the above, in the in-intersection automated LC, the forward movement is prioritized over the lateral movement. As a result, the travel control section 76 can quickly cause the subject vehicle Am to leave the intersection area IA while performing the in-intersection automated LC.

In the first embodiment, the scheduled travel route of the subject vehicle Am set in the automated driving function is grasped. Even in a case where there is no space in the subject vehicle lane Lns ahead of the intersection IS, the travel control section 76 restricts execution of the in-intersection automated LC in a direction in which the subject vehicle Am deviates from the scheduled travel route. According to the above, by performing the in-intersection automated LC, it is possible to avoid a situation in which a sudden behavior for returning to the scheduled travel route occurs in the subject vehicle Am after passing through the intersection IS.

Furthermore, in the first embodiment, in a case where the duration of the standby state of the in-intersection automated LC exceeds the upper limit standby time after the execution of the in-intersection automated LC is determined, this standby state is timed out. The upper limit standby time in the in-intersection automated LC is set to be shorter than the upper limit standby time in the out-of-intersection automated LC. According to the above, a situation in which the subject vehicle Am stays in the intersection area IA due to continuation of the standby state can be avoided.

In addition, in the first embodiment, the upper limit standby time is set to be longer at the intersection IS where the traffic signal TL is not installed than at the intersection IS where the traffic signal TL is installed. As described above, at the intersection IS where the traffic signal TL is not installed, even in a case where the subject vehicle Am stays, the subject vehicle Am is unlikely to interfere with the traffic of another vehicle. Therefore, a disadvantage caused by setting the upper limit standby time to be long is unlikely to occur. At the intersection IS without the traffic signal TL, the in-intersection automated LC is easily performed. As a result, the convenience of the automated driving can be secured.

In the first embodiment, the upper limit standby time after entering the intersection IS is set to be shorter than the upper limit standby time before entering the intersection IS. According to the above, a situation in which the standby state continues after the entry into the intersection IS and the subject vehicle Am stays in the intersection area IA can be avoided.

Further, in the first embodiment, in a case where the duration of the standby state exceeds the upper limit standby time after entering the intersection IS, the control switching section 75 performs the driving-mode switch to the driver of the subject vehicle Am. According to the execution of the driving-mode switch, the subject vehicle Am can quickly leave the intersection area IA even under a travel environment that the automated driving ECU 50 cannot cope with.

In addition, in the first embodiment, in a case where the duration of the standby state exceeds the upper limit standby time after entering the intersection IS, the travel control section 76 causes the subject vehicle Am to leave the intersection IS by a right or left turn in a direction in which the subject vehicle deviates from the scheduled travel route. As described above, the stay of the subject vehicle Am in the intersection area IA can be avoided even by a right or left turn in a direction in which the subject vehicle deviates from the scheduled travel route.

In the first embodiment, after the in-intersection automated LC is in the standby state in the intersection area IA, in a case where a space is generated ahead of the intersection IS, the travel control section 76 causes the subject vehicle Am to travel straight toward the space ahead. As described above, by canceling the in-intersection automated LC according to the situation ahead of the intersection IS, the subject vehicle Am can more smoothly leave the intersection area IA.

Further, in the first embodiment, in a case where it is determined that there is no space in the subject vehicle lane Lns ahead of the intersection IS, it is further estimated whether the congestion occurring ahead of the intersection IS continues. In a case where it is estimated that the in-intersection automated LC is in the standby state in the intersection area IA and the congestion continues, the travel control section 76 stops the subject vehicle Am in the inclined posture in which the subject vehicle moves toward the moving side in the in-intersection automated LC. In addition, in a case where it is estimated that the in-intersection automated LC is in the standby state in the intersection area IA and the congestion does not continue, the travel control section 76 stops the subject vehicle Am in the straight posture along the subject vehicle lane Lns. According to such adjustment of the stop posture, the subject vehicle Am can quickly start traveling in accordance with a change in the surroundings situation and leave the intersection area IA.

In addition, in the first embodiment, the entry vehicle Ac entering the intersection IS in the direction intersecting the subject vehicle Am is grasped. In a case where there are entry vehicles Ac on both left and right sides at the intersection IS, the travel control section 76 restricts execution of the in-intersection automated LC. According to the above, in the scene where it is difficult to recognize the situation ahead of the intersection IS by the plurality of entry vehicles Ac, the travel control section 76 can appropriately cancel the execution of the in-intersection automated LC.

In the first embodiment, in a case where the entry vehicle Ac entering the intersection IS in the direction intersecting the subject vehicle Am is grasped, it is determined whether the priority of the intersecting road CR on which the entry vehicle Ac travels is higher than the priority of the subject vehicle road on which the subject vehicle Am travels. In a case where the priority of the intersecting road CR is higher than the priority of the subject vehicle road, the travel control section 76 restricts execution of the in-intersection automated LC. According to the above, in a state where the priority of the subject vehicle Am is not high, the travel control section 76 can appropriately cancel the forcible execution of the in-intersection automated LC.

Further, in the first embodiment, the first lane change LC1 which is the out-of-intersection automated LC and the second lane change LC2 which is the in-intersection automated LC are continuously performed. At this time, the notification request section 72 makes a notification that the first lane change LC1 has shifted to the second lane change LC2. According to the above, the driver of the subject vehicle Am can grasp the current control state in the scene where the first lane change LC1 and the second lane change LC2 are performed. According to such information presentation, convenience of automated driving can be further improved.

In addition, in the first embodiment, in a case where the first lane change LC1 and the second lane change LC2 are continuously performed, the device control section 65 continues the operation of the direction indicator 44 of the subject vehicle Am. According to the above, the control state and the future behavior of the subject vehicle Am can be accurately notified to other vehicles.

In the first embodiment described above, the environment recognition section 62 corresponds to a “situation grasping section”, the notification request section 72 corresponds to a “notification execution section”, the following vehicle Ab and the entry vehicle Ac correspond to “other vehicles”, and the intersection area IA corresponds to an “intersection area”. The automated driving ECU 50 corresponds to an “automated driving control device”.

### Second Embodiment

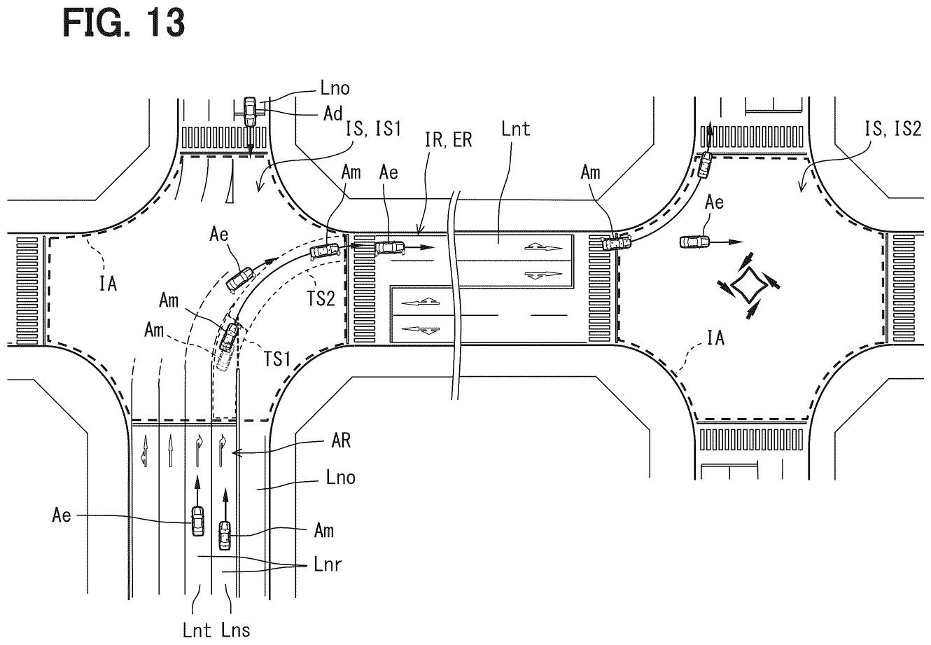

The second embodiment of the present disclosure is a modification of the first embodiment. The automated driving ECU 50 according to the second embodiment performs control related to the in-intersection automated LC in the scenes 9 to 13 to be described later, as in the scenes 1 to 8 and the like of the first embodiment. Hereinafter, details of the related control of the automated lane change performed in the scene 9 to 13 of the second embodiment will be described with reference to FIGS. 1 and 2 based on FIGS. 13 to 17.

### (Scene 9: Continuous Right or Left Turn Scene at a Plurality of Intersections)

In the scene 9 illustrated in FIG. 13, the subject vehicle Am makes consecutive right or left turns at a plurality of (two) intersections IS. As an example, the subject vehicle Am turns right at a first intersection IS1 that the subject vehicle Am enters first among the consecutive intersections, and turns left at a second intersection IS2 that the subject vehicle Am enters after leaving the first intersection IS1. Two right turn lanes Lnr are provided on an entry road AR of the first intersection IS1. The subject vehicle Am is traveling in the right right turn lane Lnr of the two right turn lanes Lnr.

Based on the route information acquired from the navigation ECU 38, the environment recognition section 62 grasps a schedule to continuously perform the right or left turn at a plurality of intersections IS. In a case where the interval between the intersections IS, that is, the interval between the centers of the first intersection IS1 and the second intersection IS2 is a predetermined distance (about 150 to 300 m) or less, the environment recognition section 62 determines that the first intersection IS1 and the second intersection IS2 are consecutive intersections. In a case where consecutive right or left turns at the first intersection IS1 and the second intersection IS2 are scheduled, the environment recognition section 62 identifies a right or left turn corresponding lane Lnt corresponding to the right or left turn at the second intersection IS2 among the plurality of lanes included in the connection road IR. The connection road IR is a road connecting the first intersection IS1 and the second intersection IS2.

In a case where a left turn is to be made at the second intersection IS2, the left (left end) lane among the plurality of lanes included in the connection road IR is the right or left turn corresponding lane Lnt. As a result, the left right turn lane Lnr is the right or left turn corresponding lane Lnt on the entry road AR at the first intersection IS1 (see FIG. 13). On the other hand, in a case where a right turn is to be made at the second intersection IS2, the right (right end) lane among the plurality of lanes of the connection road IR is the right or left turn corresponding lane Lnt. As a result, in the entry road AR of the first intersection IS1, the right right turn lane Lnr on the right side is the right or left turn corresponding lane Lnt.

The environment recognition section 62 grasps (determines) whether the subject vehicle Am has reached the right or left turn corresponding lane Lnt before entering the first intersection IS1. In the scene 9, the subject vehicle Am is traveling in the right right turn lane Lnr (subject vehicle lane Lns) which is not the right or left turn corresponding lane Lnt. A preceding vehicle Ae is present in the right or left turn corresponding lane Lnt. The preceding vehicle Ae is another vehicle that turns right at the first intersection IS1 as in the subject vehicle Am.

In a case where the subject vehicle is traveling in the right turn lane Lnr that is not the right or left turn corresponding lane Lnt before entering the first intersection IS1, the travel control section 76 attempts the in-intersection automated LC for moving from the subject vehicle lane Lns in which the subject vehicle is traveling to the right or left turn corresponding lane Lnt. In a case where the preceding vehicle Ae present in the right or left turn corresponding lane Lnt is grasped by the environment recognition section 62 before entering the first intersection IS1, the travel control section 76 suspends the automated lane change to the right or left turn corresponding lane Lnt and enters the intersection area IA of the first intersection IS1.

In a case where the subject vehicle Am has not reached the right or left turn corresponding lane Lnt before entering the first intersection IS1, the travel control section 76 decelerates to a speed lower than that of the preceding vehicle Ae and enters the intersection area IA. The travel control section 76 makes the automated lane change of moving toward the right or left turn corresponding lane Lnt in accordance with the right turn at the first intersection IS1. The travel control section 76 moves the subject vehicle Am toward a space behind the preceding vehicle Ae that exits to the right or left turn corresponding lane Lnt of the connection road IR before the subject vehicle Am by the automated lane change. The travel control section 76 causes the subject vehicle Am to travel in the right or left turn corresponding lane Lnt and turn left at the second intersection IS2.

In a case of making the lane change in accordance with the right turn at the first intersection IS1, the travel control section 76 starts leaving the subject vehicle lane Lns in a second half section TS2 of the first intersection IS1. The second half section TS2 is a section closer to an exit road ER (connection road IR) than the entry road AR in the right-turn travel section of the subject vehicle Am turning right in the intersection area IA. A section closer to the entry road AR than the exit road ER in the right-turn travel section of the subject vehicle Am is a first half section TS1. In other words, the first half section TS1 is an entrance section closer to the entry road AR than (before) the opposite lane Lno. The second half section TS2 is an exit section that crosses the opposite lane Lno and is connected to the exit road ER. The travel control section 76 starts leaving the subject vehicle lane Lns in the second half section TS2 of the intersection area IA in the automated lane change in accordance with a right or left turn not only at the first intersection IS1 of the consecutive intersections but also at the normal intersection IS.

In a case where the environment recognition section 62 grasps the oncoming vehicle Ad entering the first intersection IS1 from the opposite lane Lno, the travel control section 76 temporarily stops the subject vehicle Am in a section (first half section TS1) before the opposite lane Lno. In the intersection area IA, the travel control section 76 sets the standby stop position at which the subject vehicle waits for passage of the oncoming vehicle Ad to a position away from the exit road ER in a case where the automated lane change is made in accordance with the right turn crossing the opposite lane Lno, compared with in a case where the automated lane change is not made. In a case where the automated lane change is made in accordance with the right turn, the travel control section 76 shifts the standby stop position of the subject vehicle Am toward the center of the intersection area IA and toward the entry road AR. In this case, the subject vehicle Am stops not at a position immediately before the opposite lane Lno in the intersection area IA but at a position, before the intersection area, which is about several meters away from the opposite lane Lno.

### (Scene 10: Right Lane Change Scene for Avoiding Left Turn-Turn Entry Vehicle)

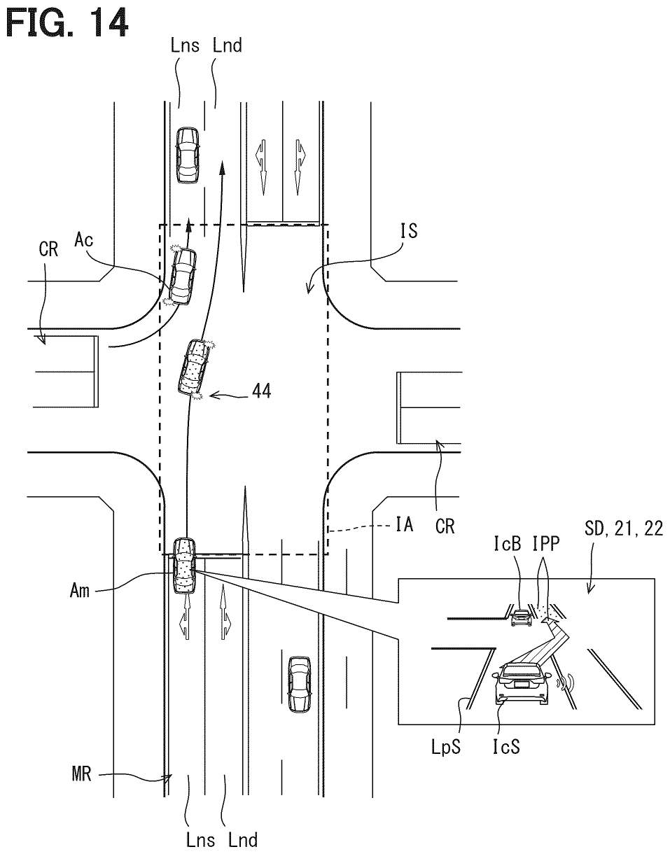

In the scene 10 illustrated in FIG. 14, as in the scene 2 (see FIG. 4) of the first embodiment, the left lane of the arterial road MR is the subject vehicle lane Lns. In the scene 10, the subject vehicle lane Lns ahead of the intersection area IA is jammed, and the entry vehicle Ac enters the subject vehicle lane Lns by a left turn from the left intersecting road CR of the intersection IS.

The environment recognition section 62 determines that there is no space for the subject vehicle Am in the subject vehicle lane Lns ahead of the intersection IS due to the entry of the entry vehicle Ac. The environment recognition section 62 determines that there is a space for the subject vehicle Am in the adjacent lane Lnd ahead of the intersection IS. The travel control section 76 determines execution of the in-intersection automated LC in the right direction in which the subject vehicle moves from the subject vehicle lane Lns to the adjacent lane Lnd in the section including the intersection IS. The travel control section 76 starts to move rightward in the vicinity of the center of the intersection area IA.

In a case where the automated lane change is made in the section including the intersection IS and the movement in the right direction is started in the vicinity of the center of the intersection area IA, the device control section 65 suspends the start of the blinking operation of the direction indicator 44 until the subject vehicle Am enters the intersection area IA. The device control section 65 starts the blinking operation of the direction indicator 44 after the subject vehicle Am enters the intersection area IA. In a case where the lateral movement is started in the second half of the intersection area IA, the device control section 65 starts the blinking operation of the direction indicator 44 after passing through the center of the intersection area IA.

Even in a case where the movement to the right is started in the vicinity of the center of the intersection area IA or after passing through the center, the notification request section 72 makes a notification of the execution schedule of the in-intersection automated LC in the direction in which the subject vehicle leaves the subject vehicle lane Lns before the blinking operation of the direction indicator 44 is started. Before entering the intersection area IA, the notification request section 72 notifies the occupant (driver or the like) in the vehicle of the execution schedule of the in-intersection automated LC by the meter display 21 or the status display SD of the CID 22.

### (Scene 11: Avoidance Scene of Emergency Vehicle)

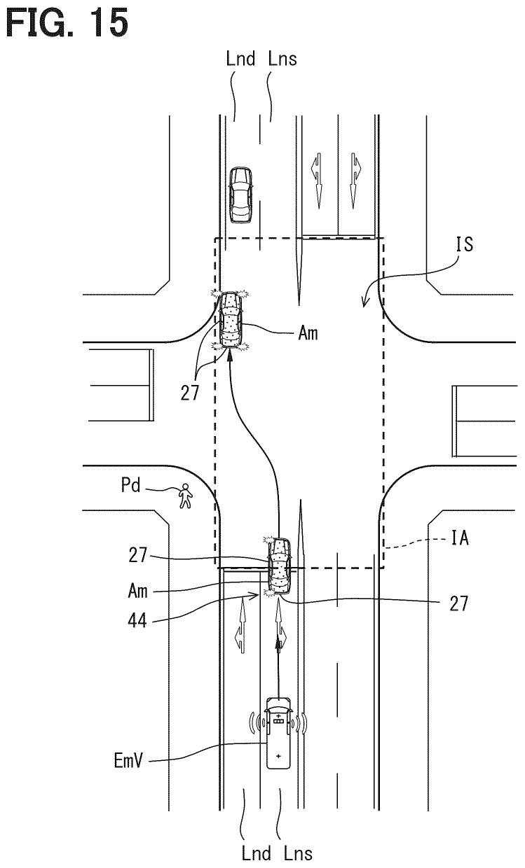

In the scene 11 illustrated in FIG. 15, the emergency vehicle EmV is approaching from behind the subject vehicle Am, as in the scene 5 (see FIG. 7) of the first embodiment. In a case where the emergency vehicle EmV is approaching from behind and the subject vehicle Am is traveling on the expected course of the emergency vehicle EmV, the travel control section 76 determines execution of the in-intersection automated LC. The travel control section 76 moves the subject vehicle Am leftward so as to leave the expected course of the emergency vehicle EmV, and moves the subject vehicle Am to the road shoulder in the intersection area IA to stop the subject vehicle Am by the in-intersection automated LC.

The out-of-vehicle display 27 is mounted on the subject vehicle Am. The out-of-vehicle display 27 is an out-of-vehicle notification device provided in the subject vehicle Am. The subject vehicle Am may further include an out-of-vehicle speaker as an out-of-vehicle notification device. The out-of-vehicle display 27 is installed on an outer face of the subject vehicle Am, such as a rear face and a side face of the subject vehicle Am. The out-of-vehicle display 27 is a display capable of displaying characters, and displays information toward the outside of the vehicle. The out-of-vehicle display 27 may be directly controlled by the notification request section 72, or may be controlled by cooperation of the notification request section 72 and the HCU 100.

In a case where the in-intersection automated LC in the direction in which the subject vehicle leaves the expected course of the emergency vehicle EmV is scheduled, the notification request section 72 notifies the another vehicle, the pedestrian Pd, and the like around the subject vehicle of the execution schedule of the in-intersection automated LC in advance using the out-of-vehicle displays 27 on the rear face and the side face before entering the intersection IS. As an example, the notification request section 72 causes the out-of-vehicle display 27 to display a character message such as “An emergency vehicle is approaching. The vehicle will change the lane and stop in the intersection” as information indicating that the execution of the automated lane change is scheduled.

In a case where the out-of-vehicle display 27 is mounted on the subject vehicle Am and the out-of-vehicle notification of the execution schedule of the in-intersection automated LC can be made, the device control section 65 starts the blinking operation of the direction indicator 44 indicating the moving direction of the subject vehicle Am in accordance with the start of the out-of-vehicle notification by the out-of-vehicle display 27. After the subject vehicle Am stops, the device control section 65 switches from the blinking operation of the direction indicator 44 to the blinking operation of the hazard lamp (emergency blinking display light).

As described above, the travel control section 76 performs the in-intersection automated LC in the direction in which the subject vehicle leaves the expected course of the emergency vehicle EmV in a state where both the blinking operation of the direction indicator 44 and the out-of-vehicle notification of the automated lane change scheduled to be made using the out-of-vehicle display 27 are performed. The subject vehicle Am waits for overtaking by the emergency vehicle EmV while continuing the blinking operation of the hazard lamp. When the passage of the emergency vehicle EmV is grasped by the environment recognition section 62, the travel control section 76 restarts the subject vehicle Am.

(Scene 12: Automated Lane Change Scene at Intersection with Traffic Signal)

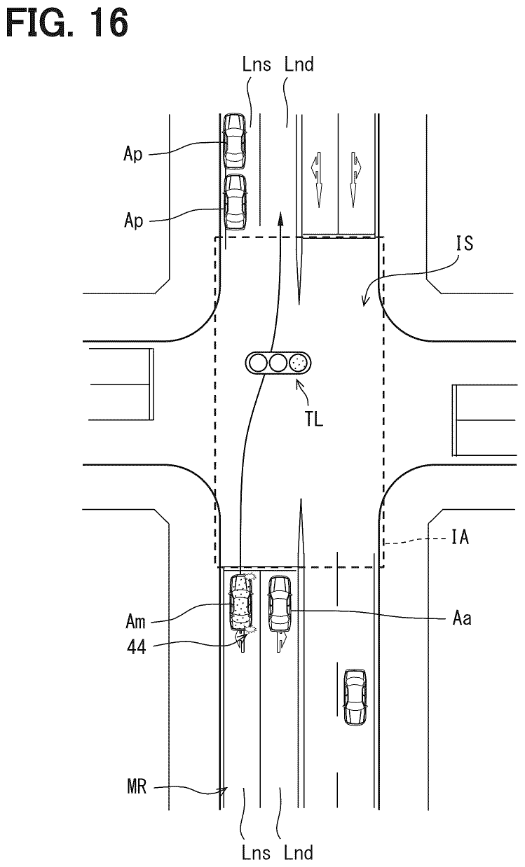

In the scene 12 illustrated in FIG. 16, the traffic signal TL is installed at the intersection IS. The subject vehicle Am is located in the left lane (subject vehicle lane Lns) among the plurality of lanes of the arterial road MR. The subject vehicle Am stops before the stop line of the intersection IS because the traffic signal TL in front of the subject vehicle is a red light. An adjacent vehicle Aa stops in the adjacent lane Lnd adjacent right of the subject vehicle lane Lns. In the scene 12, there is not the space which the subject vehicle Am enters in the subject vehicle lane Lns ahead of the intersection area IA due to a road parking vehicle Ap parked on the road in the subject vehicle lane Lns ahead of the intersection area IA. On the other hand, there is a space for the subject vehicle Am in the adjacent lane Lnd ahead of the intersection area IA.

The environment recognition section 62 grasps the lighting pattern of the traffic signal TL installed at the intersection IS. In a case where the traffic signal TL is a lighting pattern (red light) instructing stop, the environment recognition section 62 further grasps the presence or absence of the lateral adjacent vehicle Aa that stops side by side with the subject vehicle Am. The environment recognition section 62 grasps the switching of the traffic signal TL from the lighting pattern for instructing stop to the lighting pattern (green light) for permitting traveling.

In a case where there is no space in the subject vehicle lane Lns ahead of the intersection IS and the adjacent vehicle Aa is present, the travel control section 76 permits execution of the in-intersection automated LC of moving in front of the adjacent vehicle Aa after the traffic signal TL is switched from the red light to the green light. The travel control section 76 moves the subject vehicle Am to the adjacent lane Lnd ahead of the intersection IS while accelerating the subject vehicle Am at an acceleration higher than that of the adjacent vehicle Aa.

In a case where the execution of the in-intersection automated LC of moving in front of the adjacent vehicle Aa is scheduled in the subject vehicle Am that stops at the red light, the device control section 65 starts the blinking operation of the direction indicator 44 before the traffic signal TL switches to the green light. The device control section 65 performs the blinking operation of the direction indicator 44 before the start to notify the adjacent lane Lnd of the execution schedule of the automated lane change in the intersection area IA in advance.

### (Scene 13: Suspension Scene of Left Lane Change for Avoiding Right-Turn Entry Vehicle)

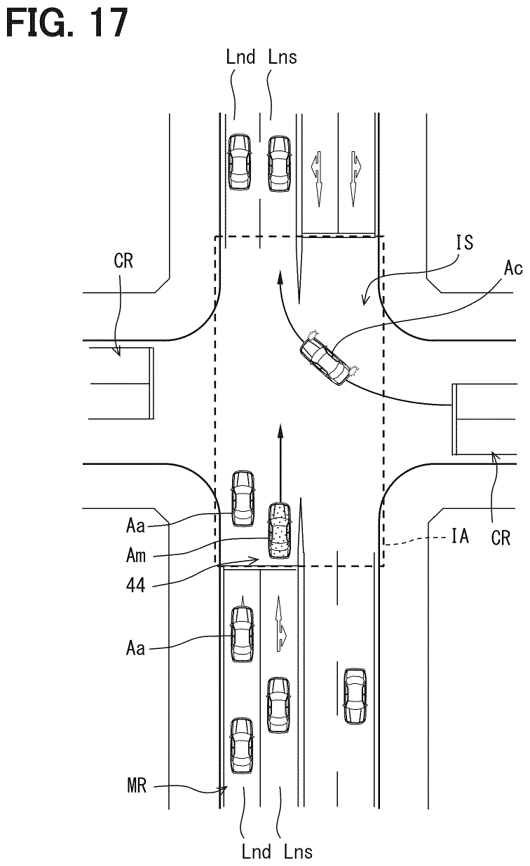

In the scene 13 illustrated in FIG. 17, as in the scene 1 (see FIG. 3) of the first embodiment, the entry vehicle Ac is entering the subject vehicle lane Lns by turning right from the right intersecting road CR of the intersection IS. The entry vehicle Ac enters immediately before the subject vehicle Am traveling in the right lane (subject vehicle lane Lns) of the arterial road MR in the intersection area IA.

The environment recognition section 62 grasps another vehicle (adjacent vehicle Aa) traveling in the adjacent lane Lnd in addition to the entry vehicle Ac in front of the subject vehicle. The environment recognition section 62 determines whether there is a space where the subject vehicle Am can move based on the presence or absence of the adjacent vehicle Aa traveling side of (left side) and rear (left rear side) of the subject vehicle Am. In a case where the amount of traffic side of and rear of the adjacent lane Lnd is large and the environment recognition section 62 determines that there is no space where the subject vehicle Am can move, the travel control section 76 suspends execution of the automated lane change to the adjacent lane Lnd even if the entry vehicle Ac enters immediately before. The travel control section 76 causes the subject vehicle Am to follow the entry vehicle Ac and causes the subject vehicle Am to enter the subject vehicle lane Lns ahead of the intersection IS.

### Overview of Second Embodiment

The second embodiment described so far exerts effects similar to those of the first embodiment are obtained, and the subject vehicle Am can be caused to leave the intersection IS by changing the traveling lane due to the automated lane change in the section including the intersection IS. According to the above, the situation in which subject vehicle Am stays in the intersection IS is less likely to occur, so that the convenience of the automated driving can be secured.

In addition, in the second embodiment, in a state in which both the blinking operation of the direction indicator 44 and the out-of-vehicle notification of the automated lane change scheduled to be performed using the out-of-vehicle display 27 are performed, the subject vehicle Am performs the in-intersection automated LC in a direction in which the subject vehicle leaves the expected course of the emergency vehicle EmV. Therefore, the subject vehicle Am can indicate to another vehicle and the pedestrian Pd around the subject vehicle and the emergency vehicle EmV behind the subject vehicle that the emergency vehicle EmV can be recognized. As a result, it is possible to more smoothly perform an action of giving way to the emergency vehicle EmV in the intersection area IA where a space is easily secured near the road shoulder.

In the second embodiment, the lighting pattern of the traffic signal TL installed at the intersection IS is grasped. In addition, in a case where the traffic signal TL is a red light, the presence or absence of the lateral adjacent vehicle Aa that stops side by side with the subject vehicle Am is further grasped. In a case where there is no space in the subject vehicle lane Lns ahead of the intersection IS and the adjacent vehicle Aa is present, the execution of the automated lane change of moving in front of the adjacent vehicle Aa after switching from the red light to the green light is permitted. Further, in a case where the execution of the automated lane change of moving in front of the adjacent vehicle Aa is scheduled, the blinking operation of the direction indicator 44 is started before the traffic signal TL is switched to the green light. According to the control of the in-intersection automated LC described above, even in a scene where the adjacent vehicle Aa is present, it is possible to cause the subject vehicle Am to leave the intersection area IA while avoiding the road parking vehicles Ap.

Further, in the second embodiment, in a case where consecutive right or left turns are scheduled at the first intersection IS1 and the second intersection IS2, it is grasped whether the vehicle has reached the right or left turn corresponding lane Lnt corresponding to the right or left turn at the second intersection IS2 before entering the first intersection IS1. In a case where the subject vehicle Am has not reached the right or left turn corresponding lane Lnt before entering the first intersection IS1, the automated lane change is performed in which the subject vehicle Am moves toward the right or left turn corresponding lane Lnt in accordance with the right or left turn at the first intersection IS1. According to the above in-intersection automated LC, the subject vehicle Am can smoothly turn right or left at the second intersection IS2 after exiting from the first intersection IS1.

In addition, in the second embodiment, in a case where the automated lane change is made in accordance with a right or left turn at the intersection IS, the vehicle starts to leave the subject vehicle lane Lns in the second half section TS2 closer to the exit road ER than the entry road AR of the intersection IS. As described above, the lane change is easily made in the intersection area IA by making the automated lane change accompanying the right or left turn near the exit of the intersection IS. Further, since the subject vehicle Am stays in the subject vehicle lane Lns in the first half section TS1, the subject vehicle Am can wait for passage of the oncoming vehicle Ad at a position where the subject vehicle is less likely to obstruct traveling of another vehicle around the subject vehicle.

In the second embodiment, the standby stop position at which the subject vehicle waits for passage of the oncoming vehicle Ad is set to a position away from the exit road ER in a case where the in-intersection automated LC is performed in accordance with the right or left turn crossing the opposite lane Lno, compared with in a case where the in-intersection automated LC is not performed. According to such adjustment of the standby stop position, a long distance from the standby stop position to the intersection exit is secured, and the subject vehicle Am can be positioned rear of the preceding vehicle Ae traveling in the destination lane. As a result, the success rate of the in-intersection automated LC can be improved.

Further, in the second embodiment, in a case where the automated lane change to the direction in which the subject vehicle leaves the subject vehicle lane Lns in the section including the intersection IS is made, the blinking operation of the direction indicator 44 is started after the subject vehicle passes through the center of the intersection IS. When the blinking operation of the direction indicator 44 is started before or immediately after entry into the intersection area IA, there is a possibility that another vehicle around the subject vehicle will make an erroneous recognition if the subject vehicle Am turns right or left instead of making a lane change. Therefore, in a case where the in-intersection automated LC is performed, it is possible to avoid false recognition by another vehicle by control of starting the blinking operation of the direction indicator 44 to start after entering the intersection area IA, desirably after passing through the center of the intersection IS.

In addition, in the second embodiment, before the blinking operation of the direction indicator 44 is started, the execution schedule of the automated lane change to the direction in which the subject vehicle leaves the subject vehicle lane Lns is notified. According to the above, even when the start of the operation of the direction indicator 44 is delayed until the subject vehicle passes near the center of the intersection area IA, it is possible to notify the occupant of the subject vehicle Am of the execution schedule of the automated lane change at an early stage.

In the second embodiment, when the subject vehicle Am tries to perform the in-intersection automated LC, in a case where the travel amount at the adjacent lane Lnd is large, the control of suspending the in-intersection automated LC and following the entry vehicle Ac is performed. According to the above, whether the automated lane change is made can be appropriately determined according to the jam situation in the vicinity of the intersection IS. In the second embodiment, the out-of-vehicle display 27 corresponds to an “out-of-vehicle notification device”.

### Other Embodiments

Although a plurality of embodiments according to the present disclosure has been described above, the present disclosure is not to be construed as being limited to the above embodiments, and can be applied to various embodiments and combinations without departing from the gist of the present disclosure.

In the above embodiment, in a case where there is no space in the subject vehicle lane Lns ahead of the intersection IS, the presence or absence of a space in the adjacent lane Lnd is further determined (see S15 in FIG. 11). On the other hand, in the first modification of the above embodiment, the determination of the presence or absence of a space for the adjacent lane Lnd is omitted. In the second modification of the above embodiment, the presence or absence of a space in the adjacent lane Lnd is determined according to the moving direction of the in-intersection automated LC. As an example, it is determined whether there is a space in the adjacent lane Lnd in the automated lane change to the right side, and such determination is omitted in the automated lane change to the left side.

In the third modification of the above embodiment, the control content of the in-intersection automated LC is changed between in a case where the driver is obliged to monitor the surroundings and in a case where the driver is not obliged to monitor the surroundings. As an example, the travel control section 76 suppresses the traveling speed of the subject vehicle Am in the in-intersection automated LC in a case where the driver has no obligation to monitor the surroundings, compared with in a case where the driver has an obligation to monitor the surroundings. For example, each of the above-described restriction conditions for restricting the execution of the in-intersection automated LC may be applied to only one of the driving assistance control and the autonomous travel control. Further, in a case where the automated lane change is in the standby state in the intersection area IA, the control switching section 75 may request the driver to perform surroundings monitoring in cooperation with the notification request section 72.

In the above embodiment, the intersection area IA is a range between stop lines of the subject vehicle road. However, for example, at an intersection IS where there is a crosswalk PC, a range between two crosswalks PC may be the intersection area IA. Further, the form of the intersection IS is not limited to the cross as in the above embodiment. For example, execution of the in-intersection automated LC may be determined at intersections of various forms, such as a multi-way intersection (a six-way intersection or the like), a Y-shaped intersection, a T-shaped intersection, and an annular intersection (roundabout).

In the fourth modification of the second embodiment, the notification request section 72 determines the presence or absence of the available out-of-vehicle display 27. In a case where the out-of-vehicle display 27 is not mounted on the subject vehicle Am, the device control section 65 omits the blinking operation of the direction indicator 44 and starts the blinking operation of the hazard lamps in accordance with the start of the control of the automated lane change. That is, the subject vehicle Am moves to the road shoulder in the intersection area IA with the hazard lamp blinking.

In the above embodiment, the control content of the automated lane change is described on the premise of the traffic environment in which the subject vehicle travels on the right side. The control related to the automated lane change of the present disclosure (automated lane change control) can be applied to a traffic environment where the subject vehicle travels on the left side. In other words, the vehicle equipped with the automated driving ECU and the HMI system may be a right-hand drive vehicle or a left-hand drive vehicle. The automated lane change control according to the present disclosure may be appropriately optimized according to the road traffic law of each country and region, the steering wheel position of the vehicle, and the like.

Specifically, the content of the control of making the lane change to the right in the traffic environment where the vehicle travels on the left side is applicable to the control of making the lane change to left in the traffic environment where the vehicle travels on the right side. Similarly, the content of the control of making the lane change to the left side in the traffic environment where the vehicle travels on the left side is applicable to the control of making the lane change to the right side in the traffic environment where the vehicle travels on the right side.

In addition, in a traffic environment in which the vehicle travels on the left side, a right turn is intersection passing that crossing the opposite lane Lno, and a left turn is intersection passing that not crossing the opposite lane Lno. On the other hand, in a traffic environment where the vehicle travels on the right side, a left turn is intersection passing that crossing the opposite lane Lno, and a right turn is intersection passing that not crossing the opposite lane Lno. The control related to the right or left turn described above can be applied to a traffic environment in which the vehicle travels on the right side by switching the right and the left.

In the fifth modification of the above embodiment, the driving assistance ECU that performs the driving assistance control at Level 2 is provided separately from the automated driving ECU 50. As in the fifth modification, the automated driving system including the plurality of in-vehicle ECUs may correspond to an “automated driving control device”.

In the sixth modification of the above embodiment, each function of the automated driving ECU 50 and the HCU 100 is provided by one integrated ECU. In the sixth modification, the integrated ECU corresponds to an “automated driving control device”.

In the above embodiment, each function provided by the automated driving ECU and the HCU can be provided by software and hardware for executing the software, only software, only hardware, or a combination thereof. Furthermore, in a case where such a function is provided by an electronic circuit as hardware, each function can be provided by a digital circuit including a large number of logic circuits or an analog circuit. Furthermore, the software for realizing such a function may include, at least in part, a code automatically generated by a neural network or a language model trained using a camera image in the real world, for example.

Each processing section of the above-described embodiment has a configuration including at least one arithmetic core such as a central processing unit (CPU) and a graphics processing unit (GPU). The processing section may further include a field-programmable gate array (FPGA), a neural network processing unit (NPU), an IP core having another dedicated function, and the like. The processing section is not limited to the configuration individually mounted on the printed circuit board. The processing section may be implemented in an application specific integrated circuit (ASIC), a system on chip (SoC), a chiplet integrated body, an FPGA, or the like.

The form of the storage medium (continuous tangible computer reading medium, non-transitory tangible storage medium) that stores various programs and the like may be appropriately changed. Furthermore, the storage medium is not limited to the configuration provided on the circuit board, and may be provided in the form of a memory card or the like, inserted into the slot portion, and electrically connected to a control circuit such as an automated driving ECU or an HCU. Furthermore, the storage medium may be an optical disk, a hard disk drive, a solid state drive, or the like that is a copy source or a distribution source of a program to the automated driving ECU or the HCU.

The vehicle on which the automated driving ECU and the HMI system are mounted is not limited to a general private car, and may be a vehicle for a rental car, a vehicle for a manned taxi, a vehicle for ride-sharing, a cargo vehicle, a bus, or the like.

The control unit and its method described in the present disclosure may be implemented by a dedicated computer comprising a processor programmed to execute one or more functions embodied by a computer program. Alternatively, the apparatus and its method described in the present disclosure may be implemented by dedicated hardware logic circuits. Further, the apparatus and its method described in the present disclosure may be implemented by one or more dedicated computers configured by a combination of a processor that executes a computer program and one or more hardware logic circuits. In addition, the computer program may be stored as instructions executable by a computer on a computer-readable, non-transitory, tangible recording medium.

What is claimed is:

1. An automated driving control device that enables traveling of a subject vehicle by an automated driving function, comprising
at least one of (i) a circuit and (ii) a processor with a memory storing computer program code executable by the processor, the at least one of the circuit and the processor configured to cause the automated driving control device to implement:
a situation grasping section configured to grasp, in a scene where the subject vehicle is scheduled to pass through an intersection, whether there is a space for the subject vehicle in a subject vehicle lane ahead of the intersection; and
a travel control section configured to determine, in a case where there is not the space in the subject vehicle lane, execution of a lane change in a direction in which the subject vehicle leaves the subject vehicle lane in a section including the intersection;
wherein
the travel control section makes a lateral vector generated in the subject vehicle in the lane change in the section including the intersection smaller than a lateral vector in the lane change in a section not including the intersection.

2. The automated driving control device according to claim 1, wherein:
the situation grasping section determines whether the subject vehicle has entered the intersection; and
the travel control section
determines execution of the lane change in a case where it is determined that there is not the space in the subject vehicle lane after the subject vehicle enters the intersection, and
suspends execution of the lane change in a case where it is determined that there is not the space in the subject vehicle lane before the subject vehicle enters the intersection.

3. The automated driving control device according to claim 1, wherein
the travel control section changes a traveling speed of the subject vehicle according to a left-right moving direction in the lane change.

4. The automated driving control device according to claim 1, wherein
the situation grasping section determines whether a pedestrian is present in a waiting area facing the intersection, and
the travel control section suppresses a traveling speed of the subject vehicle in the lane change in a case where the pedestrian is present in the waiting area, compared with in a case where the pedestrian is not present in the waiting area.

5. The automated driving control device according to claim 1, wherein
the situation grasping section determines whether surroundings of the subject vehicle are in bad weather, and
the travel control section restricts execution of the lane change in a section including the intersection in a case where the surroundings of the subject vehicle is in the bad weather.

6. The automated driving control device according to claim 1, wherein
the situation grasping section grasps a scale of the intersection through which the subject vehicle is scheduled to pass, and
the travel control section changes a determination criterion as to whether to permit the lane change in a section including the intersection according to the scale of the intersection.

7. The automated driving control device according to claim 1, wherein
the situation grasping section recognizes an emergency vehicle approaching the subject vehicle from behind, and
in a case where the emergency vehicle is recognized, the travel control section permits execution of the lane change in a direction in which the subject vehicle leaves an expected course of the emergency vehicle in a section including the intersection.

8. The automated driving control device according to claim 1, wherein
the situation grasping section grasps whether a traffic signal is installed at the intersection, and
the travel control section makes it easier to determine execution of the lane change at an intersection where the traffic signal is not installed than at an intersection where the traffic signal is installed.

9. The automated driving control device according to claim 1, wherein
the situation grasping section
grasps a lighting pattern of a traffic signal installed at the intersection, and
further grasps presence or absence of a lateral adjacent vehicle that stops side by side with the subject vehicle in a case where the traffic signal is in the lighting pattern for instructing stop,
in a case where there is not the space in the subject vehicle lane ahead of the intersection and the adjacent vehicle is present, the travel control section permits execution of the lane change in which the subject vehicle moves in front of the adjacent vehicle after switching from a lighting pattern for instructing stop to a lighting pattern for permitting traveling, and
the automated driving control device further comprises a device control section that starts a blinking operation of a direction indicator of the subject vehicle before the traffic signal is switched to the lighting pattern for permitting traveling in a case where execution of the lane change for moving forward of the adjacent vehicle is scheduled.

10. The automated driving control device according to claim 1, wherein
the travel control section sets a lower limit speed at which execution of the lane change in a section including the intersection is permitted to be lower than a lower limit speed at which execution of the lane change in a section not including the intersection is permitted.

11. The automated driving control device according to claim 1, wherein
the situation grasping section grasps behavior prediction information for predicting a future behavior in a left-right direction of another vehicle located around the subject vehicle, and
the travel control section determines whether to start the lane change in a section including the intersection using the behavior prediction information.

12. The automated driving control device according to claim 1, wherein
the travel control section sets a minimum inter-vehicle distance that permits execution of the lane change in a section including the intersection to be shorter than a minimum inter-vehicle distance that permits execution of the lane change in a section not including the intersection.

13. The automated driving control device according to claim 1, wherein
the situation grasping section determines whether a pedestrian is present in a waiting area facing the intersection, and
the travel control section makes a lateral vector generated in the subject vehicle in the lane change in which the subject vehicle approaches the pedestrian smaller than a lateral vector in the lane change in which the subject vehicle is away from the pedestrian.

14. The automated driving control device according to claim 1, wherein
the travel control section sets a completion point of the lane change in a section including the intersection to a point ahead of the intersection.

15. The automated driving control device according to claim 1, wherein
the situation grasping section grasps a scheduled travel route of the subject vehicle set in the automated driving function, and
the travel control section restricts execution of the lane change in a direction in which the subject vehicle deviates from the scheduled travel route even in a case where there is not the space in the subject vehicle lane ahead of the intersection.

16. The automated driving control device according to claim 1, wherein
the travel control section
times out a standby state in a case where a duration of a standby state of the lane change exceeds an upper limit standby time after execution of the lane change is decided, and
sets an upper limit standby time in the lane change in a section including the intersection to be shorter than an upper limit standby time in the lane change in a section not including the intersection.

17. The automated driving control device according to claim 1, wherein
the situation grasping section grasps whether a traffic signal is installed at the intersection, and
the travel control section
times out a standby state in a case where a duration of a standby state of the lane change exceeds an upper limit standby time after execution of the lane change is decided, and
sets the upper limit standby time at an intersection where the traffic signal is not installed longer than at an intersection where the traffic signal is installed.

18. An automated driving control device that enables traveling of a subject vehicle by an automated driving function, comprising
at least one of (i) a circuit and (ii) a processor with a memory storing computer program code executable by the processor, the at least one of the circuit and the processor configured to cause the automated driving control device to implement:
a situation grasping section configured to grasp, in a scene where the subject vehicle is scheduled to pass through an intersection, grasps whether there is a space for the subject vehicle in a subject vehicle lane ahead of the intersection; and
a travel control section configured to determine, in a case where there is not the space in the subject vehicle lane, execution of a lane change in a direction in which the subject vehicle leaves the subject vehicle lane in a section including the intersection;
wherein
the situation grasping section determines whether a pedestrian is present in a waiting area facing the intersection, and
the travel control section, in a case where the pedestrian is present in the waiting area, completes the lane change within an area of the intersection.

19. An automated driving control device that enables traveling of a subject vehicle by an automated driving function, comprising
at least one of (i) a circuit and (ii) a processor with a memory storing computer program code executable by the processor, the at least one of the circuit and the processor configured to cause the automated driving control device to implement:
a situation grasping section configured to grasp, in a scene where the subject vehicle is scheduled to pass through an intersection, whether there is a space for the subject vehicle in a subject vehicle lane ahead of the intersection; and
a travel control section configured to determine, in a case where there is not the space in the subject vehicle lane, execution of a lane change in a direction in which the subject vehicle leaves the subject vehicle lane in a section including the intersection;
wherein
the situation grasping section grasps whether a crosswalk is provided at the intersection, and
the travel control section, in a case where the crosswalk is provided at the intersection, completes the lane change before the crosswalk.

20. The automated driving control device according to claim 19, wherein
the situation grasping section determines whether a pedestrian who is scheduled to cross the crosswalk is present, and
in a case where the pedestrian is present, the travel control section causes the subject vehicle to wait in front of the crosswalk after completing the lane change in front of the crosswalk.
